(19) United States
(12) Patent Application Publication
(10) Pub. No.: US 2025/0086737 A1
(43) Pub. Date: Mar. 13, 2025

(54) ARTIFICIAL INTELLIGENCE-BASED IDEA DISCOVERY AND FEEDBACK SYSTEM AND METHOD

(71) Applicant: IP Copilot, Inc., Columbia, TN (US)

(72) Inventors: Austin Grant Walters, Columbia, TN (US); Jeremy Edward Goodsitt, Champaign, IL (US); Grant Mitchell Eden, San Francisco, CA (US)

(21) Appl. No.: 18/827,795

(22) Filed: Sep. 8, 2024

Related U.S. Application Data
(60) Provisional application No. 63/537,425, filed on Sep. 8, 2023.

(51) Int. Cl. G06Q 50/18; G06Q 30/0202; H04L 51/216

(52) U.S. Cl. CPC G06Q 50/184; G06Q 30/0202; H04L 51/216

(57) ABSTRACT

Embodiments are directed to methods and systems for inventions disclosure and automated disclosure form generation.

### CROSS-REFERENCE TO RELATED APPLICATIONS

This application claims priority to U.S. Provisional Application No. 63/537,425, entitled “Artificial Intelligence-Based Idea Discovery and Feedback.”

### BACKGROUND

The invention disclosure process is a formal procedure where inventors provide detailed information about their invention to an organization, such as a university or company. This process protects intellectual property rights by establishing a documented record of the invention. Additionally, it facilitates technology transfer by enabling organizations to evaluate the commercial potential of inventions and explore opportunities for licensing or further development. The process typically involves inventors preparing a comprehensive disclosure, including technical descriptions, drawings, and experimental data. They then submit this information using a standardized form provided by the receiving entity. The entity evaluates the invention's novelty, patentability, and market potential before making a decision on further action, such as filing a patent application or licensing the technology. Prompt and detailed invention disclosure is crucial for protecting intellectual property, ensuring compliance with regulations, and potentially leading to commercial success.

The invention disclosure process, while essential, is not without its challenges. One common issue is the complexity and time-consuming nature of preparing a comprehensive disclosure, which can deter inventors, particularly those with limited resources or experience. Moreover, there can be ambiguity in determining inventorship and ownership, especially in collaborative research settings, leading to potential disputes. The evaluation process itself can be lengthy and subjective, with variations in assessment criteria and decision-making across different organizations. Furthermore, concerns about confidentiality and potential conflicts of interest can arise, particularly when inventions involve sensitive information or competing commercial interests. These challenges underscore the need for streamlined procedures, clear guidelines, and effective communication between inventors and receiving entities to ensure a smooth and successful invention disclosure process.

### BRIEF SUMMARY

In one aspect, embodiments include a computer-implemented method. The method includes sending a query to a prior art system to identify related prior art for a newly identified idea, and determining a patentability score, a business value score, a detectability score, or a combination thereof. The method further includes determining whether additional information for the newly identified idea is required based on the patentability score, the business value score, the detectability score, or the combination thereof. The method includes repeatedly requesting the additional information on one or more communication mediums of a business system in response to continuing determining the additional information is required or a timeout event occurs, and performing one or more actions in response to the additional information is not required, where the one or more actions includes presenting data based on the patentability score, the business value score, the detectability score, or the combination thereof. The method also includes generating a disclosure form for the newly identified idea, notifying a system associated with a portfolio manager, or a combination thereof. In some instances, the method may be implemented in a computer-readable medium and processed by a processor.

Further, embodiments include a computing apparatus that includes a processor and memory. The memory includes storing instructions that, when executed by the processor, configure the apparatus to send a query to a prior art system to identify related prior art for a newly identified idea, determine a patentability score, a business value score, a detectability score, or a combination thereof, determine whether additional information for the newly identified idea is required based on the patentability score, the business value score, the detectability score, or the combination thereof, repeatedly request the additional information on one or more communication mediums of a business system in response to continuing determining the additional information is required or a timeout event occur, and perform one or more actions in response to the additional information is not required, where the one or more actions includes presenting data based on the patentability score, the business value score, the detectability score, or the combination thereof, generating a disclosure form for the newly identified idea, notifying a system associated with a portfolio manager, or a combination thereof.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system 100 in accordance with embodiments discussed herein.

FIG. 2 illustrates aspects of system 100 in accordance with embodiments discussed herein.

FIG. 3 illustrates a routine 300 in accordance with one embodiment.

FIG. 4 illustrates a routine 400 in accordance with one embodiment.

FIG. 5 illustrates an aspect of the subject matter in accordance with one embodiment.

FIG. 6 illustrates an aspect of the subject matter in accordance with one embodiment.

FIG. 7 illustrates a routine 700 in accordance with one embodiment.

FIG. 8A-8C illustrates an example of a display 800 in accordance with embodiments.

FIG. 9 illustrates a system 900 in accordance with one embodiment.

FIG. 10 illustrates an apparatus 1000 in accordance with one embodiment.

FIG. 11 illustrates an artificial intelligence architecture 1100 in accordance with one embodiment.

FIG. 12 illustrates an artificial neural network 1200 in accordance with one embodiment.

FIG. 13 illustrates a computer-readable storage medium 1302 in accordance with one embodiment.

FIG. 14 illustrates a computing architecture 1400 in accordance with one embodiment.

FIG. 15 illustrates a communications architecture 1500 in accordance with one embodiment.

### DETAILED DESCRIPTION

Many discussions about inventions, including work products or potential ideas, are discussed over varying mediums of communication without connection to the possibility of it being considered intellectual property. These can be brainstorming sessions in a meeting room, conversations over chat apps like Slack or Zoom, email, or brief hallway discussions. Each of these moments of communication has an opportunity to create and discover new valuable intellectual property. However, these communications typically get lost in the weeds and are not captured unless they are the focus area of an organization and through dedicated efforts for discovery and capture. In addition, ideas or conversations of implementation of ideas could infringe on existing patents without the intention of the developers.

When intellectual property is captured, it is usually done via a paper or online form. When filling out a form, users typically have free will to interact and write whatever they want outside of using text-based rules or text filtering systems. However, these systems do not handle cases when the user does not fill out a form in the intended way by the form developer or ultimate intended user of the form response. In some cases, a user might require additional knowledge or resources to support filling out the form that provides clear, instructive feedback about how to properly fill out the form. Otherwise, downstream costs of utilizing form responses can increase substantially.

When developing an invention disclosure, the goal is to clearly communicate the invention idea and what problem it is solving in addition to distinguishing the new invention from the existing prior art. This involves intricate knowledge of the invention disclosure process and prior art in the field of the new invention. Ultimately, without this familiarity, the cost to invent may increase or result in a loss of intellectual property coverage due to rejection.

Embodiments discussed herein are directed to improving previous invention discovery solutions. Specifically, embodiments include invention discovery techniques to identify new inventions. Embodiments also include a smart disclosure form system, where once an idea is discovered, the system helps the user automatically generate disclosure forms with a real-time feedback process.

In one example, embodiments are include methods and systems for artificial intelligence (AI) based idea discovery including utilization of prior art comparison with real-time conversations. Embodiments include a system with communication monitoring services to identify current discussions, which could convert into an organization's intellectual property (IP) asset, or ensure the development of a critical feature within a company will not lead to an infringement on existing techniques. This can be done by automating the process of triggering alerts when specific criteria are met (e.g., slack message on the idea, email with the conversation and patentability score, alert to the internal IP counsel, etc.) or even auto-generation of a patent draft itself given an idea.

Embodiments include a system that monitors various communication channels, and when a user discusses an idea, it records and analyzes the conversation using a machine-learning model. If the communication does not meet a certain threshold, the analysis stops; if the system is unsure, it may wait for further communication. Otherwise, the system identifies the start of the idea discussion. It continues tracking it across multiple mediums until the conversation ends, potentially linking new communication to a previous idea if relevant.

In embodiments, the system reformats the captured idea into a structure suitable for prior art analysis, potentially an invention disclosure, a large language model input, another ML model format, or an embedding for comparison. This reformatted idea is then sent to the prior art comparison system, which may utilize classification to narrow the search and can return various outputs, including idea classification, relevant prior art, questions, business eligibility, patentability score, and more.

Upon receiving results from the comparison system, if the patentability value is low, no further action is taken unless new context emerges. If the system is unsure, it may provide questions to the user or initiate a conversation to gather more information. For high patentability ideas, the system will either ask the user provided questions or log the idea as patentable, potentially generating a disclosure form, notifying the user, alerting internal counsel, or even automatically pushing it to external counsel based on classification or previous work.

The system will continue monitoring the idea until it's deemed unviable, new information contradicts its viability, the disclosure is submitted, or receives any indication to cease tracking. Additionally, the system might proactively uncover patentable concepts within an organization by analyzing documents and conversations, identifying unique ideas and assessing the author's expertise in relevant technology areas.

Embodiments further include an automatic generation disclosure form system. The system enables AI based real-time feedback on form field input based on prior art comparison. In order to enhance invention disclosure submissions by seasoned and new inventors, the system may utilize real-time feedback given to inventors at the time of writing their invention disclosure. The system may offer feedback on the disclosure's clarity, providing suggestions for improvement or confirming its effectiveness. It can also assess the disclosure's separation from prior art, including questions and instructions for elaboration, or indicate if no feedback is needed. Finally, the system may provide a comprehensive quality score, encompassing clarity, prior art conflict, idea validity, business evaluation, and other relevant factors.

The inventor experience begins with accessing the invention disclosure form and filling out sections. As they input text, an AI processing component analyzes it in real-time, generating feedback and a score. This feedback, potentially accompanied by animated elements or highlights, is presented to the inventor, who can then use it to refine their disclosure. The AI might suggest the disclosure is ready for submission, highlight areas for improvement, or prevent submission until certain criteria are met, allowing for inventor overrides in some cases. If the required threshold or critical comments are not addressed, the process iterates until the disclosure is either deemed satisfactory or overridden, at which point the inventor can submit.

In embodiments, the AI component may initially receive initialization details like its role and task, along with information about the disclosure such as the text, prior art, and previous responses. It might then gather additional information, including disclosure classification, nearest prior art (determined via various methods as discussed herein), and the ideal law firm for the disclosure. This prior art search can be refined using different filters, and the law firm's selection might be based on classification, prior art, or previous IDF handling experience and feedback. Additional details are discussed in the following description.

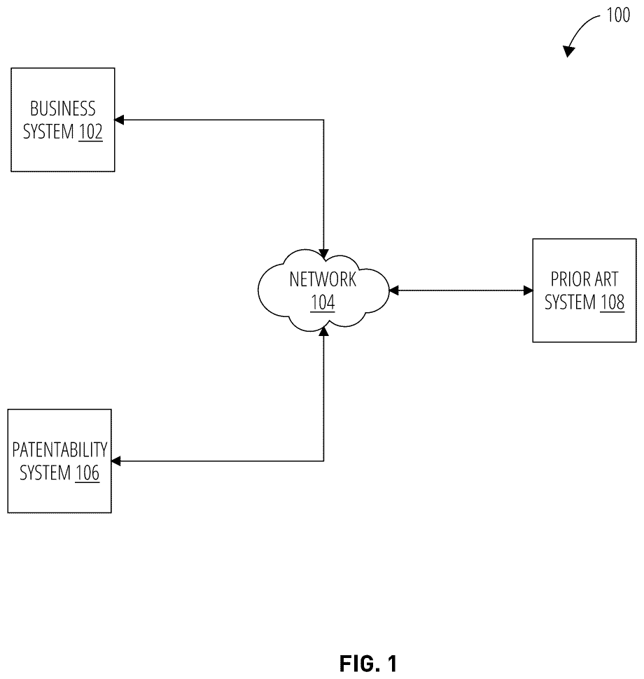

FIG. 1 illustrates an example of a system 100 in accordance with embodiments discussed herein. System 100 includes systems and components that enable users and businesses to identify high-quality patentable assets and file a patent application. At a high level, the system 100 monitors communication medium(s) to identify and score potential Intellectual Property (IP) assets, trigger alerts based on communication content and patentability score, and automatically generate a patent disclosure based on a scored idea. The system 100 includes a business system 102, a patentability system 106, and a prior art system 108 coupled via a network 104 to perform the operations discussed herein.

The system 100 also includes a machine learning (ML) model for idea analysis and categorization, and the ability to compare ideas against prior art using a large language model (LLM) or other ML model. The system 100 can also discover patentable concepts within an organization based on content and conversations and identify unique patentable ideas based on an embedding search. The system tracks communication until it is deemed over, and can continue tracking new communication if it is determined to be discussing the same invention. The system 100 can compare ideas against prior art for classification, prior art references, generation of follow-up questions, business eligibility, patentability scores, and other relevant information. The System 100 can also log ideas until they are no longer viable, submitted for a patent, or determined to be not feasible based on prior art, continued conversation, business value, or internal/external firm reviews. In other aspects, the system 100 provides real-time feedback and scoring for form responses, such as those utilized to submit invention ideas, e.g., invention disclosure form, by using AI and additional prior art comparisons. The system 100 analyzes form responses in real time, providing suggestions and feedback on response quality, clarity, and relevance to known topics.

The system 100 illustrates systems coupled via a network 104 to perform the operations discussed herein. In embodiments, the system 100 may include one or more business systems 102, which may be monitored by a patentability system 106. A business system 102 includes a combination of processes, tools, and technologies to achieve specific organizational goals and objectives. These systems streamline operations, improve efficiency, and enhance decision-making. They typically include software applications for areas such as customer relationship management (CRM), enterprise resource planning (ERP), supply chain management (SCM), and human resources management (HRM). Business systems integrate various functions to provide a cohesive view of the organization, facilitating better resource allocation and strategic planning.

The Business System 102 includes computing hardware, including the physical components that support an organization's computing and networking needs. These components are essential for running software applications, storing data, and enabling communication and collaboration. In embodiments the business system 102 includes servers, workstations, desktop computers, laptops and mobile devices. The business system 102 also includes networking equipment such as routers, switches, and firewalls that facilitate communication between computers and secure network operations. The business system 102 also includes storage solutions, such as hard drives, solid-state drives, Network Attached Storage (NAS), and Storage Area Networks (SAN) that provide data storage and retrieval capabilities. The business system 102 may also include auxiliary devices like printers, scanners, monitors, and keyboards that enhance user interaction and productivity. In some embodiments, the business system 102 may be deployed in facilities housing multiple servers and storage systems, ensuring reliable and scalable information technology (IT) infrastructure for larger organizations. These hardware components form the backbone of an organization's IT infrastructure, ensuring the efficient performance and reliability of business systems.

In embodiments, business system 102, including networking, enables communication via one or more communication mediums. The communication mediums are the channels through which information is transmitted from one entity or employee to another. These can be broadly categorized into verbal communication, non-verbal communication, and digital communication channels. As will be discussed, embodiments include monitoring the digital communication channels, such as social media platforms, instant messaging applications, electronic mail (e-mail) and video conferencing tools. A digital communication channel may enable internal and/or external communication to the business system 102, and it is a medium that uses electronic technologies to transmit information and facilitate interactions. The channels may enable real-time or asynchronous communication, connecting individuals and organizations across the various platforms.

In embodiments, the system 100 includes a patentability system 106 configured to monitor the communication mediums of the business system 102, detect patentability idea, analyze patentable ideas, and provide feedback. The patentability system 106 includes high-performance, scalable physical components designed to support the extensive computing needs of large organizations. These components ensure robust, reliable, and secure operations, which are critical for handling substantial data volumes and complex applications. For example, the patentability system 106 includes one or more servers that manage network resources, host applications, run databases, and provide centralized storage and computing services. Additionally, the system incorporates critical storage and network solutions, such as Storage Area Networks (SAN) that offer high-speed, block-level storage essential for enterprise-level data management. Network Attached Storage (NAS) provides dedicated file storage connected to a network, allowing multiple users to access and share files seamlessly. To maintain efficient communication and robust security within the network, the system includes essential networking equipment like routers and switches that facilitate data traffic management, ensuring optimal performance and connectivity. Firewalls and security appliances are integral components that protect the network from threats and unauthorized access, maintaining the integrity and confidentiality of critical data. Together, these elements form a comprehensive infrastructure capable of supporting the demanding requirements of large enterprise business systems, ensuring that data is processed, stored, and transmitted efficiently and securely.

In embodiments, system 100 includes a prior art system 108, which may be utilized by patentability system 106 to identify related prior art for ideas identified from business system 102. The prior art system 108 includes a data store or a data repository that stores existing knowledge, technology, inventions, or publications that are relevant to the novelty and originality of a new invention or patent application. It includes anything made available to the public before a given date, such as patents, published patent applications, scientific papers, products, and other forms of documentation. Prior art can be used to assess whether an invention is new and non-obvious, which are critical criteria for patentability.

In one example, the prior art system 108 may include the United States Patent Office (USPTO) databases of patents, patent applications, and non-patent literature. The prior art system 108 may include a third-party database, such as Google's® patent database. Other prior art system 108 include other Internet databases including other patent databases (such as the EPO, and WIPO), scientific publications and journals (like PubMed, IEEE Xplore, SpringerLink, ScienceDirect, and ResearchGate), technical documentation (including standards and company white papers), online repositories and libraries (like arXiv, JSTOR, and the ACM Digital Library), industry publications (such as trade journals), and other sources (like theses and archived websites). These sources collectively provide comprehensive coverage of prior art across various fields and industries and may be accessed by the patentability system 106 to perform the operations discussed herein.

In embodiments, the prior art system 108 includes other data stores, such as company corpuses, storage or websites like confluence. By incorporating internal corporate repositories, which house patents, trade secrets, and other intellectual property assets held by the company or organization, embodiments can cross-reference novel concepts against in-house data. This integration helps identify potential conflicts of interest, assess competitive advantages, and avoid redundancy within a single entity's portfolio. Some embodiments may utilize data solutions and platforms such as Confluence that provide collaborative environments where information is centralized and easily accessible to various stakeholders involved in the innovation process. By linking with these platforms, the prior art system 108 can draw on collective insights, documented ideas, research notes, and project updates that may be pertinent to evaluating new concepts. The prior art system 108 may gather data from other websites. In addition to curated databases, external websites offer a wealth of information not confined within proprietary systems. By incorporating data from these sources—including open-source repositories, academic journals, industry publications, and more—the prior art system gains access to a broader spectrum of relevant knowledge that could influence the assessment of new ideas' originality, innovation level, and potential market impact.

In some instances, the prior art system 108 may determine data via a retrieval augmented generation (RAG) process. The Retrieval Augmented Generation (RAG) process is an approach for data acquisition and analysis. The RAG process may be an amalgamation of retrieval-based methods, which involve querying databases to find relevant information, with generative models that can produce new content based on existing knowledge. In embodiments, the prior art system 108 initiates by searching through extensive patent and non-patent literature using advanced search algorithms. It looks for patterns, keywords, or citation networks that could indicate similarities with the newly identified idea. Generative models such as language models (e.g., GPT series) are employed by the prior art system 108 to synthesize new hypotheses about a concept's novelty and potential applications by extrapolating from existing data. This could involve generating descriptions of how the idea might be implemented or its possible implications in various fields. The RAG process merges these two components, with retrieval providing a foundation for understanding what is already known while generation expands on that base to propose new directions and insights. For example, if the retrieval component finds numerous patents related to an idea's core concept but none cover its specific application, the generative model could suggest unexplored areas or applications based on this gap in knowledge. This RAG process enhances the prior art system 108 by not only identifying relevant existing information but also actively contributing to the innovation landscape through informed conjecture and hypothesis generation. It thus serves as a powerful tool for both assessing intellectual property's novelty and stimulating further research and development efforts in line with emerging technological trends.

In some embodiments, the prior art system 108 provides filters that enable users to turn on and off various data sources. These filters allow users to manage which data sources contribute to the analysis process dynamically. For example, the prior art system 108 provides source selection controls. Users can interact with an interface provided by the prior art system 108 that presents various data source options—such as patent databases, company corpuses, academic journals, industry publications, or external websites like Confluence. These controls enable them to selectively include or exclude each source based on their relevance and the specific requirements of a given inquiry. The prior art system 108 also provides real-time adjustment capabilities. As users navigate through different phases of idea evaluation—from initial conceptualization to detailed analysis—they can adjust these filters in real-time, for example. This flexibility ensures that only pertinent data feeds into their search and assessment processes, thereby saving time and enhancing the accuracy of results. Implementations may incorporate context awareness, allowing filters to adapt based on previous searches or user roles (e.g., patent attorney aspects that are more relevant for legal assessments or market analysts). This dynamic adjustment ensures users receive tailored information pertinent to their immediate needs and expertise level. By providing such filters, the prior art system 108 empowers users with granular control over data collection and analysis, enabling them to construct comprehensive and focused insights into new ideas' intellectual property landscape efficiently. This capability is crucial in a fast-paced environment where timely decision-making can significantly impact an organization's innovation trajectory and competitive positioning.

In embodiments, the patentability system 106 provides features and services for the newly identified ideas through the patent process. For example, the patentability system 106 provides an AI-enhanced disclosure submission process. Specifically, to enhance the submissions, the patentability system 106 may provide real-time feedback to users on the business system 102. The AI-enhanced disclosure submission process aims to improve the quality and effectiveness of patent applications submitted by inventors or organizations. This advanced approach utilizes machine learning algorithms and natural language processing (NLP) technologies to analyze submissions in real-time. The patentability system 106 plays an integral role within this system; it provides users with instantaneous, data-driven insights on their patent applications. By offering valuable suggestions for improvement and highlighting potential issues or areas of concern, the feedback service empowers applicants to refine their submissions more effectively.

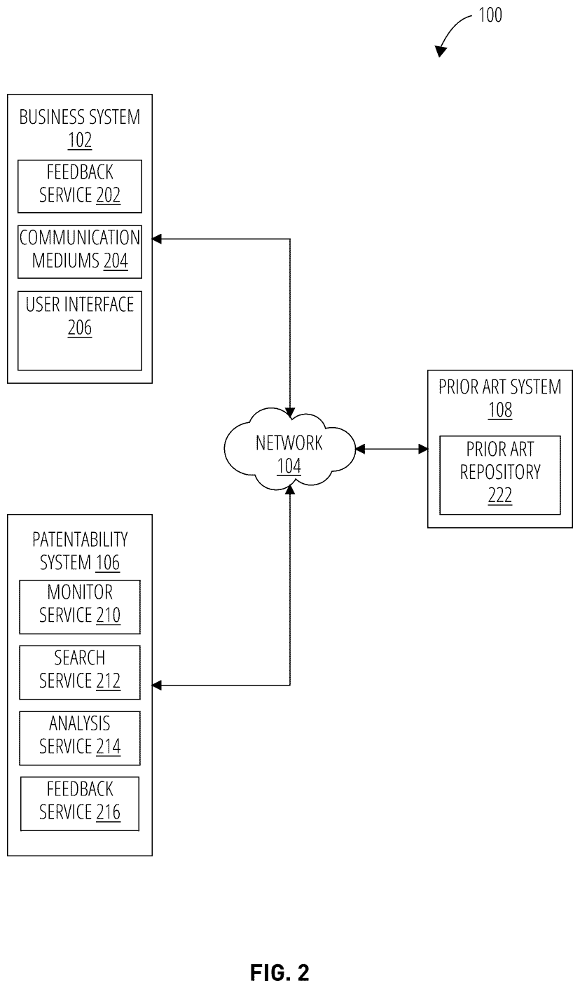

FIG. 2 illustrates a detailed example of the system 100 in accordance with the embodiments discussed herein. Specifically, FIG. 2 illustrates system 100 having additional services and components. Note that FIG. 2 only illustrates a limited number of components, and the implementation of the systems of system 100 may have other components.

In embodiments, the components of each of the systems, the business system 102, the patentability system 106, and the prior art system 108 may communicate with each other via network 104 to provide the services and features discussed herein. For example, the patentability system 106 includes hardware and software components, including a monitor service 210, a search service 212, an analysis service 214, and a feedback service 216. Each service will be discussed in detail in the following description.

In embodiments, the monitor service 210 monitors the communication mediums 204 of the business system 102, including overseeing the various channels and tools utilized for internal and external interactions. This includes email, instant messaging platforms, teleconferencing systems, project management software, and social media networks. In embodiments, the monitor service 210 monitors the communication mediums 204 for a topic or keywords using one or techniques primarily focused on analyzing the text content of messages and channels. For example, the monitor service 210 may perform keyword matching by scanning messages for specific keywords or phrases related to the topic of interest. The monitor service 210 may utilize string matching algorithms or more sophisticated techniques like regular expressions to capture variations in wording. In another example, the monitor service 210 uses natural language processing (NLP) to identify keywords or topics. Utilizing the NLP enables the monitor service 210 to understand the meaning and context of messages, going beyond simple keyword matching. For example, the monitor service 210 may perform a sentiment analysis to determine the overall emotional tone of a message (positive, negative, neutral) to gauge the sentiment around a topic. In another example, the monitor service 210 may perform another NLP technique, such as topic modeling, to identify the main themes and subjects discussed in a channel or conversation, even without pre-defined keywords. In some embodiments, the monitor service 210 may perform entity recognition to extract names of people, places, organizations, and other relevant entities mentioned with the topic.

In some instances, monitor service 210 may utilize machine learning (ML) to identify topics, such as inventive ideas. For example, the monitor service 210 may utilize an ML trained on large datasets, such as Internet content, to learn patterns and associations related to specific topics and inventions. The monitor service 210 may process communications from the communication mediums 204 to classify messages, e.g., automatically categorize messages based on their relevance to the topic or inventive idea, filtering out irrelevant noise. In some instances, the monitor service 210 may utilize a model to identify trends in communication and detect new or evolving discussions related to the topic. The monitor service 210 may also use ML to predict future developments and potential issues or opportunities related to the topic based on historical conversation patterns.

In some instances, the monitor service 210 uses an ML model to generate a score or categorization for a discussion. An ML model can be utilized to generate a score or categorization for communications by analyzing textual data and identifying relevant patterns. The monitor service 210 may collect the data from the communication mediums 204, and perform preprocessing. For example, the monitor service 210 may include cleaning and normalizing the text data by removing stopwords, punctuation, and special characters, then performing tokenization (breaking down sentences into individual words) and stemming or lemmatization (reducing words to their base forms). The monitor service 210 may then perform feature extraction, including transforming preprocessed textual data into numerical features that can be understood by the ML algorithm using techniques like bag-of-words, TF-IDF (Term Frequency-Inverse Document Frequency), or word, phrase, sentence, or document embeddings (like Word2Vec and BERT). The monitor service 210 may score the data from the communication mediums 204 to assign an appropriate categorization based on the data content.

In some instances, the monitor service 210 may determine if the collected data meets a threshold score, categorization, etc., of the ML model; if not, the monitor service 210 stops the analysis. For example, if monitor service 210 determines the discussion is in a category the business specified as “not interesting” previously, further analysis may be halted. Specifically, the monitor service 210 may determine a confidence score for the topic and if it is above a threshold (say 70%) that the topic being discussed is not interesting based on business settings, the monitor service 210 stops processing further. In another example, the monitor service may determine that there are not enough technical terms being utilized on the same topic (i.e. consistency), further processing may be halted or additional prompts may be presented. In a third example, if the monitor service 210 determines that the expertise of the users discussing does not align with what's being discussed, the monitor service 210 may halt further processing.

In some instances, the monitor service 210 may determine if a score is below the first threshold but above a second threshold) and may wait for more communication to better categorize the initial communication. If the monitor service 210 determines the communication data meets a threshold, the monitor service 210 determines the beginning and end of the communication for a specific topic. In some instances, the monitor service 210 continues to monitor a communication until the end is detected. For example, the monitor service 210 may determine a timeout has occurred, e.g., an x amount of time has passed since the last communication. In another example, the monitor service 210 may determine whether a new topic is being discussed. In embodiments, the monitor service 210 may determine a communication is over and then detect a reopening of the topic later, e.g., via topic identification. Sometimes, the communication data may be collected from multiple communication mediums 204, e.g., a chat channel and an email channel.

The monitor service 210 is designed to enhance the capabilities of applications by incorporating real-time or near-real-time communication mediums monitoring. This integration with an application programming interface (API) allows for seamless interfacing between different software components, e.g., the monitor service 210 and a communication application (Slack, Outlook, Teams, etc.) enabling efficient data exchange and processing. Moreover, this API integration facilitates access to channel data from various sources, such as social media platforms or online discussion forums. By analyzing the communication in real-time, the monitor service 210 can detect specific patterns or keywords that indicate significant events (e.g., beginning or ending events) or discussions taking place within these channels. In summary, by integrating an API into its functionality, the monitor service 210 enhances real-time communication capabilities within various applications, leading to improved monitoring and more accurate alerting of significant events or discussions of inventive ideas across different channels.

The patentability system 106 may further process a discussion of a newly identified idea to help enhance disclosure material, identify patentable concepts, and process the filing of a patent application. In embodiments, the patentability system 106 determines the patentability of a newly identified idea from the data in the monitored channels. In one example, the patentability system 106 performs a prior art search via a search service 212. Specifically, the search service 212 searches one or more prior art systems 108, which have prior art repositories 222 of possible prior art to the topic. A prior art system 108 is a comprehensive, organized collection of information that documents all existing knowledge and creations related to a particular subject matter or inventive idea and may be stored in a prior art repository 222. This includes any publicly available data, such as patents, scientific papers, technical writings, or other publications, as well as products, inventions, processes, and designs disclosed by others.

In embodiments, a prior art system 108 may be a patent database, such as national and international patent offices maintaining extensive databases of granted and published patents that provide valuable information on existing inventions related to a particular subject matter. Some popular global patent databases include the United States Patent and Trademark Office (USPTO), European Patent Office (EPO), World Intellectual Property Organization (WIPO) PATENTSCOPE, and Google Patents. The prior art system 108 may include scientific journals with research papers published in journals that often contain information about new inventions or discoveries that can serve as prior art for related subject matters. Other examples include book repositories, conference proceedings, and other online databases.

The search service 212 may interface with the prior art system 108 via one or more API interfaces provided by the prior art system 108. In embodiments, the search service 212 may format or put the data corresponding with the topic into a new or different format to perform the prior art analysis, e.g., a format specified by the prior art system 108. For example, the search service 212 may put the data into an invention disclosure form, e.g., title, abstract, description, inventive date, etc. In another example, the search service 212 may put the data into a format processable by an ML model or a large language model (LLM) and convert it into an embedding that describes the data and idea in vector form or another comparable format for comparison to other ideas from the prior art systems 108.

The formatted data may be utilized by the search service 212 to perform a search to identify other ideas that are similar to the identified idea. In embodiments, the search service 212 may utilize the classification of the identified ideas to narrow a prior art search. In another example, the search service 212 may utilize any of the keywords of the identified idea to conduct the prior art search. For example, the search service 212 uses a vector form of the data (text) of the identified idea to perform a keyword search. For example, the search service 212 converts the text corresponding to the identified idea and text of the prior art repository 222 into high-dimensional vectors in a mathematical space, e.g., using techniques like TF-IDF (Term Frequency-Inverse Document Frequency) or embeddings. This approach enables efficient retrieval by comparing the semantic similarity between query terms and document content. When the search service 212 uses TF-IDF, it represents each document by assigning weight to its terms based on their frequency within a text and inverse frequency across all text. This method emphasizes terms more unique to a particular document while downplaying common ones. Alternatively, the search service 212, utilizing word (phrase, sentence, or document) embeddings, converts words into dense, high-dimensional vectors that capture the semantic relationships between different terms. These representations can account for synonyms or related concepts by placing semantically similar words close together in the vector space.

The search service 212 generates a query representation, e.g., the search query from the text of the identified idea using the same term representation method as the documents (TF-IDF or word embeddings) to create a corresponding high-dimensional vector. The search service 212 may query the prior art system 108 for related ideas, e.g., text, patents, published applications, etc., and the analysis service 214 may perform an analysis. Specifically, the analysis service 214 may determine similar documents and perform a similarity measurement to determine how similar.

In embodiments, the analysis service 214 performs a similarity measurement to identify relevant documents, e.g., a query vector is compared with document vectors in the collection by calculating their similarity. In one example, the analysis service 214 utilizes a cosine similarity or Euclidean distance to measure the similarity between the identified idea and ideas returned in the search. The cosine similarity measures the angle between two vectors (query (newly identified idea) and document (returned prior art)) in high-dimensional space; it ranges from 0 to 1, where values closer to 1 indicate higher similarity. Alternatively, the Euclidean distance calculates the straight-line distance between two points in space, with smaller distances indicating greater similarity.

In embodiments, the analysis service 214 ranks the ideas similar to the newly identified idea. Specifically, the searched documents are ranked based on their similarity scores to the query vector for the newly identified idea. The most similar documents (highest cosine similarity) are presented as search results for the user. The number of results may be based on a cosine similarity score threshold, a fixed number of documents, or some other criteria. Using a vector form approach to keyword searching allows more accurate and context-aware retrieval of information, especially in cases where simple keyword matching may not be sufficient due to synonyms or related concepts. This process is discussed in more below.

In embodiments, the analysis service 214 generates a patentability score to assess whether newly identified ideas are likely to be patentable. This scoring system compares these new concepts with existing prior art using cosine similarity or Euclidean distance as semantic similarity measures between documents (prior art) and the newly discovered idea represented by its vector form.

The analysis service 214 performs the following operations to determine the Cosine Similarity-based Patentability Score Generation. The search service 212 first searches through relevant databases, patents, publications, and other sources of information to find documents that are semantically similar to the newly identified idea. The analysis service 214 computes cosine similarity scores, e.g., each document in the search results is represented as a vector using TF-IDF or word embeddings; then, the analysis service 214 calculates the cosine similarity between this vector and the vector representing the new concept. The analysis service 214 determines the patentability score. For example, the analysis service 214 counts the number of documents with a cosine similarity value greater than or equal to a pre-defined threshold (e.g., 0.75). Based on this count, the analysis service 214 generates a numerical patentability score between 0 and 100 for each new idea, where higher scores indicate better chances of being patentable. If the number of similar documents exceeds or meets the pre-defined threshold, the newly identified concept may not be novel compared to existing prior art. Conversely, if there are no or few such documents within the set similarity range, the new idea may be considered novel and/or non-obvious and, therefore, more likely to meet patentability criteria. In some instances, the analysis service 214 may have different thresholds between different types of documents and similarities in types of documents. For example, a score for a disclosure compared to a patent may have a different threshold than a patent is being compared to another patent because of the specificity and languages between each. This helps normalize across to give proper scoring.

In some embodiments, the analysis service 214 computes the Euclidean Distance-based Patentability Score. The analysis service 214 computes the Euclidean distances between the vector representation of each document (prior art) and the new idea's vector form, which reflects their semantic similarity in terms of how far apart they are in multi-dimensional space. The analysis service 214 assess a patentability score, e.g., counts the number of documents whose Euclidean distance falls within a predefined range from the new idea's vector representation (e.g., less than or equal to 0.5). Based on this count, it generates a numerical patentability score between 0 and 100 for each newly identified concept. More documents with small Euclidean distances suggest that the new idea is novel and non-obvious compared to existing prior art, indicating better chances of being granted a patent. Conversely, if there are many similar documents within close proximity (small Euclidean distance), it may indicate that the newly identified concept lacks uniqueness or obviousness in light of existing knowledge and thus has lower chances of meeting patentability criteria. The generated scores represent an initial assessment of a new idea's potential for being granted a patent based on its novelty and non-obviousness, as determined by comparing it to the available prior art.

In addition to generating patentability scores, the analysis service 214 also assesses various other aspects of new ideas to provide a comprehensive evaluation. For example, the analysis service 214 may perform classification and topic-based Categorization. In example, the analysis service 214 classify the new idea based on patent classification. The analysis service 214 evaluates the prior art documents identified during the search against existing patent classifications, such as those defined by international standards like the International Patent Classification (IPC) or national systems. By matching these documents to specific classes and subclasses, it helps categorize the new idea within the broader landscape of intellectual property rights. In another example, the analysis service 214 may perform a topic-based classification. The service analyzes both prior art and the newly discovered concept's content using natural language processing techniques (e.g., topic modeling) or keyword extraction algorithms to identify prevalent topics, themes, or subject areas related to the invention. This allows for a more granular understanding of how the new idea fits into existing knowledge domains.

The analysis service 214 may also generate additional prompts or questions and requests for clarification. For example, the analysis service 214 generates questions that inventors may need to address while refining their patent applications or disclosures. These queries aim to clarify aspects of the invention, distinguish it from prior art, and emphasize its novelty or non-obviousness. Some examples include identifying topics not discussed in prior art by comparing search results with content of new ideas. The service pinpoints areas that could potentially enhance patentability by highlighting unique aspects of the invention. The analysis service 214 also determines completeness and detail level. The analysis service 214 examines whether inventors have sufficiently described their invention to enable others skilled in the art to replicate it without undue experimentation. This assessment helps ensure that patent applications provide a clear understanding of the innovation's scope, functioning, and technical nuances. The analysis service 214 generates questions for additional details based on the assessment, e.g., asking how a specific topic/discussion is performed.

The analysis service 214 may also determine business eligibility. The analysis service 214 evaluates whether the new idea aligns with business-related criteria necessary for obtaining a patent. This includes determining if it pertains to products or processes that can be commercialized within an industry's context, examining its relevance and practicality in current market trends, and assessing potential applications in relevant business sectors. The analysis service 214 may also determine detectability for enforcement. The service analyzes the concept's detectability to determine if it can be effectively enforced against later implementors or competitors who may attempt to utilize similar ideas without authorization. This evaluation involves assessing uniqueness, technical complexity, and potential market impact. By combining these various analyses, inventors, patent attorneys, and business stakeholders can comprehensively understand the new idea's intellectual property landscape, commercial viability, and legal implications for future protection and enforcement strategies.

In embodiments, the analysis service 214 performs one or more actions based on the above analysis(es). For example, if the value of the patentability score is below a given threshold value or criteria, the analysis service 214 may take no further action for the newly identified idea. If the patentability score is above a particular threshold and below another threshold, the analysis service 214 may perform an action such as asking the inventors for additional information, factoring in the business value, factoring detectability, or performing another action. If the patentability score exceeds the threshold, the analysis service 214 may generate a “disclosure form” for the newly identified idea to submit for further review, e.g., send it to a portfolio manager, patent attorney, business manager, etc. The disclosure form may be text in a document form that includes information, such as the inventors, a title of the invention, and a description of the invention.

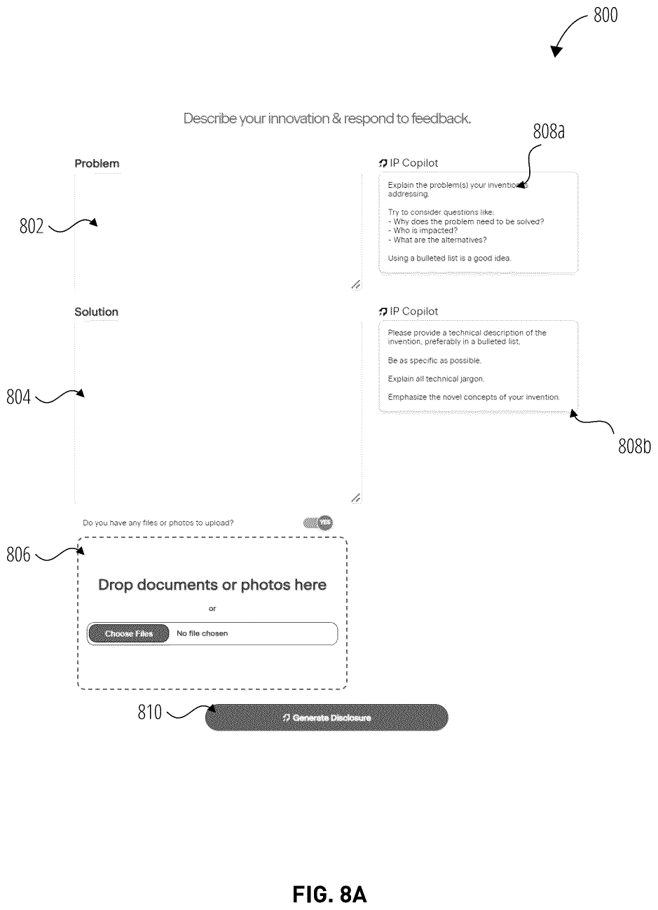

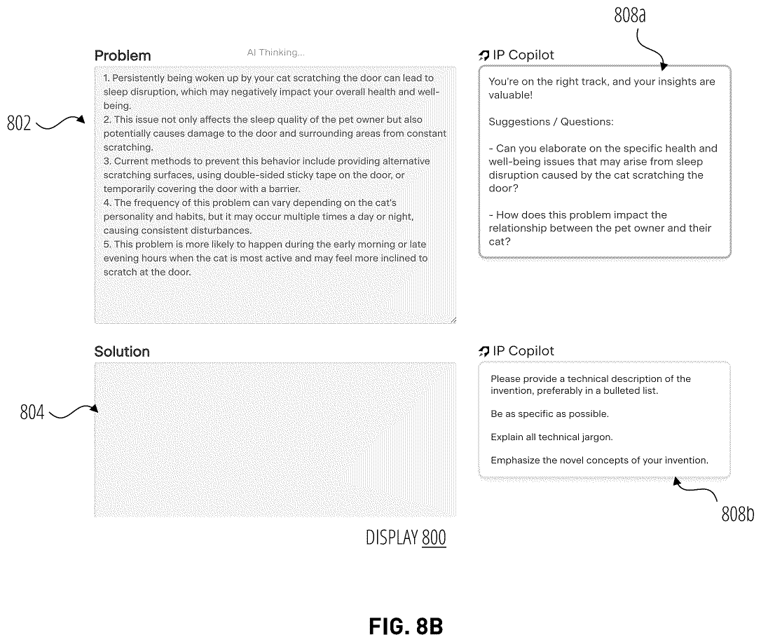

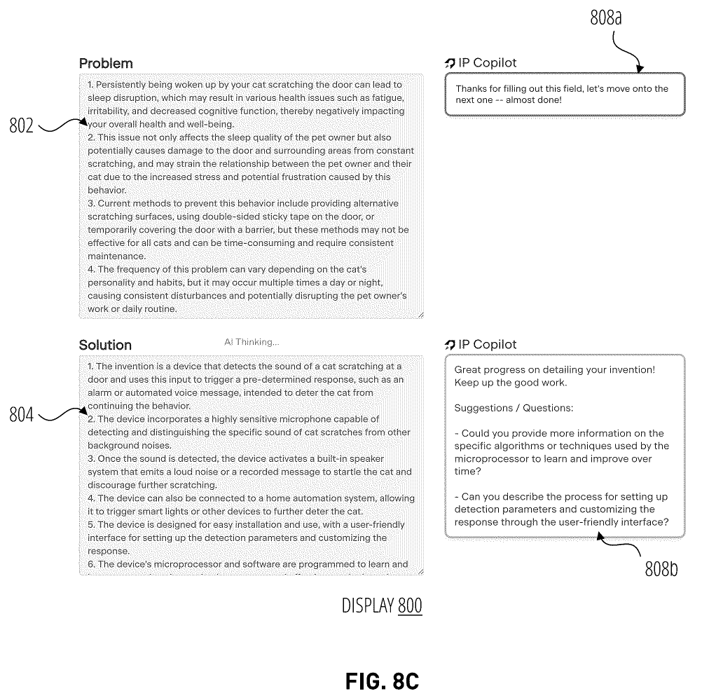

In some instances, the analysis service 214 may request additional information. The feedback service 216 may ask questions, such as generic questions about the idea, e.g., describe the idea in more detail, or more targeted questions, e.g., explain the pre-processing of data for the model as illustrated and discussed in FIGS. 8A-8C. Specifically, the feedback service 216 may communicate with the feedback service 202 of the business system 102. A user of the business system 102 may communicate with patentability system 106 via the user interface 206 and feedback service 202. The analysis service 214 may update the patentability score, the business value, detectability value, etc., based on the responses provided by an inventor.

In embodiments, the analysis service 214 may assess the patentability of an idea based on predefined patentability scores that serve as benchmarks for evaluating the new concepts' potential value and feasibility for protection. When the score falls below a certain threshold, no further action is taken; this helps in conserving resources by focusing efforts only on ideas with a higher likelihood of success. For those ideas surpassing an initial patentability threshold but still not meeting another upper limit, additional actions are triggered to refine and enhance the idea's prospects. These may include requesting more in-depth information from inventors, which could provide insights into the technical aspects or novelty of the concept, evaluating business value by considering market demand, potential revenue streams, and alignment with strategic goals, and determining the detectability of the idea. The business value may be a score given to a newly identified idea based on various factors. Generating a business value score for a patent involves a multi-faceted approach that considers various factors related to the patent's potential impact on a business. These factors may include prior art, technical feasibility, market potential (size/growth, landscape, customer needs), and business impact (revenue potential, competitive advantage, risk mitigation). The analysis service 214 may generate a business value, such as a weighted score, by assigning weights to each factor based on their relative importance to the business, combining quantitative metrics (e.g., market size, potential revenue) with qualitative assessments (e.g., technical feasibility, competitive advantage), involve subject matter experts, patent attorneys, and business analysts to provide insights and validate assessments. The business value score may be relative to prior inventions, similar patents or industry benchmarks. The final output is a business value score that reflects the patent's potential contribution to the company's overall success. In embodiments, the analysis service 214 can also generate a detectability score assessing detectability risks to determine how easily a business can identify a competitor's implementation of the idea, thus affecting its commercial viability and implementing alternative measures that could involve design modifications or seeking expert advice for improving patentability. The analysis service 214 may generate a detectability score for a patent by assessing how easily an infringement of that patent can be identified and proven based on one or more factors. The factors include the nature of the newly identified idea (physical versus non-physical, visible versus hidden, standardized versus custom), and industry and market factors (transparency, competition, reverse engineering). The analysis service 214 may generate a detectability score based on these factors. For example, the analysis service 214 may generate a score from a lower value to an upper value with a scale ranging from “Very Low” to “Very High” detectability, with descriptive criteria for each level based on the factors above. In some instances, the score may be based on input from patent attorneys, technical experts, and industry professionals evaluating the patent and assigning a score. In some instances, factors may be assigned based on their relative importance for detectability in the specific context of the invention and market. The detectability score may be a relative score based on similar patents in the same field to gauge its relative detectability. The final detectability score is a valuable indicator of the patent's enforceability and potential value.

In embodiments, the analysis service 214, based on the analysis and one or more scores, generates a disclosure form, e.g., when one or more of the patentability score, the business value score, and/or the detectability score meets or exceeds threshold values. In some instances, a combination of the scores may be used to determine whether additional information is needed, or the process may proceed to generate a disclosure form and/or proceed with filing a patent. The disclosure form encapsulates vital information about the invention: inventors' names, a succinct title, and a comprehensive description. This form aims to facilitate thorough review by key stakeholders, such as portfolio managers or patent attorneys, who can then make informed decisions regarding further development, filing for patents, or commercialization strategies. Additionally, the feedback service 216 plays a pivotal role in enriching the evaluation process by posing questions to inventors and other relevant parties. These queries may range from general inquiries about the idea's conceptual framework to specific technical aspects like data pre-processing for machine learning models. By gathering this feedback, which is relayed through the business system 102's feedback service 202, the analysis service 214 can dynamically update the scores, e.g., patentability score, business value, detectability, and other relevant metrics based on inventors' responses. This iterative process ensures a comprehensive understanding of each idea's potential while maintaining alignment with organizational objectives and IP strategies.

Thus, when the patentability score, business value, detectability score, or combination thereof indicates a high potential for intellectual property protection, the patentability system 106 initiates a series of actions to ensure that the concept is properly documented and reviewed. If inventors or other stakeholders are provided questions related to the invention, the patentability system 106 and the business system 102 provide a chat or dialog system, e.g., one of the communication mediums 204, that serves as a conduit for further clarification and discussion. Once, the 106, including the analysis service 214, determines the newly identified idea should be patented, the analysis service 214 generates the disclosure form. The generated disclosure form can be directly shared with users via a secure link by the feedback service 216, enabling them to access and review it at their convenience. To maintain transparency and build trust, the patentability system 106 continuous communication regarding the idea's progress is recorded and integrated automatically into the disclosure document as comments or notes. Users have the option to exclude irrelevant remarks from this record, e.g., via the feedback service 202 of the business system 102.

In embodiments, the patentability system 106 communicates the patentability status of the idea through various channels, such as email updates, in-system notifications, or direct messages, keeping inventors informed about their creation's potential for protection under IP laws. In some instances, the patentability system 106 notifies internal counsel promptly, which may lead to an automatic referral of the disclosure form to external patent attorneys based on predefined criteria or machine learning algorithms that analyze classifications and prior work by reputed law firms. In addition, the patentability system 106 The system diligently monitors the idea's development until the idea is filed as a patent at a patent office (USPTO, EPO, WIPO, etc.). This comprehensive process not only streamlines patent filing and management but also upholds a high standard of diligence and accuracy throughout an invention's lifecycle from conception to potential legal protection.

As previously mentioned, the patentability system 106 also enables users to perform an iterative process to generate a disclosure form. The feedback service 216 provides real-time feedback (prompts) and insights into the clarity of the disclosure in communicating the idea, separation of the disclosure from the prior art, and a score for the quality of the disclosure. The feedback service 216 may clarify the disclosure by providing details on improving communication (e.g., bullet points, numbered lists, questions about the invention, etc.), and clarity for a specific reviewer/attorney. By providing real-time, data-driven insights and recommendations, feedback service 216 helps inventors enhance their submissions to meet stringent standards for novelty, clarity, and non-obviousness. One of the primary functions of the feedback service 216 is evaluating the clarity with which an idea or invention is communicated through a disclosure document by processing information provided in fields, such as a problem field or a solution field. The feedback service 216 analyzes various aspects of the application, such as its organization, language use, and overall structure. To improve communication, the feedback service 216 suggests modifications like bullet points, numbered lists, and specific questions to explain better technical concepts or inventive steps related to the invention, as illustrated in FIGS. 8A-8C. Another critical aspect that the feedback service 216 assesses is how well a disclosure distinguishes itself from prior art-previous patents, publications, or other publicly available information. By analyzing the language and content of an application against existing literature, it can help inventors identify areas where their invention may be too similar to previously known technologies.

This evaluation helps applicants highlight unique features that set their innovation apart from prior art. In addition to these factors, the feedback service 216 assigns a quality score for each disclosure based on its adherence to patentability criteria and overall comprehension.

These scores can serve as valuable benchmarks for inventors seeking to improve their submissions or comparing their work against other applications in progress. By providing specific, actionable feedback tailored to individual reviewers' or attorneys' needs, feedback service 216 helps applicants address weaknesses and fortify their patent claims effectively. As a result, it contributes significantly to creating robust disclosures that can withstand scrutiny during the examination process and increase the likelihood of obtaining valuable intellectual property protection.

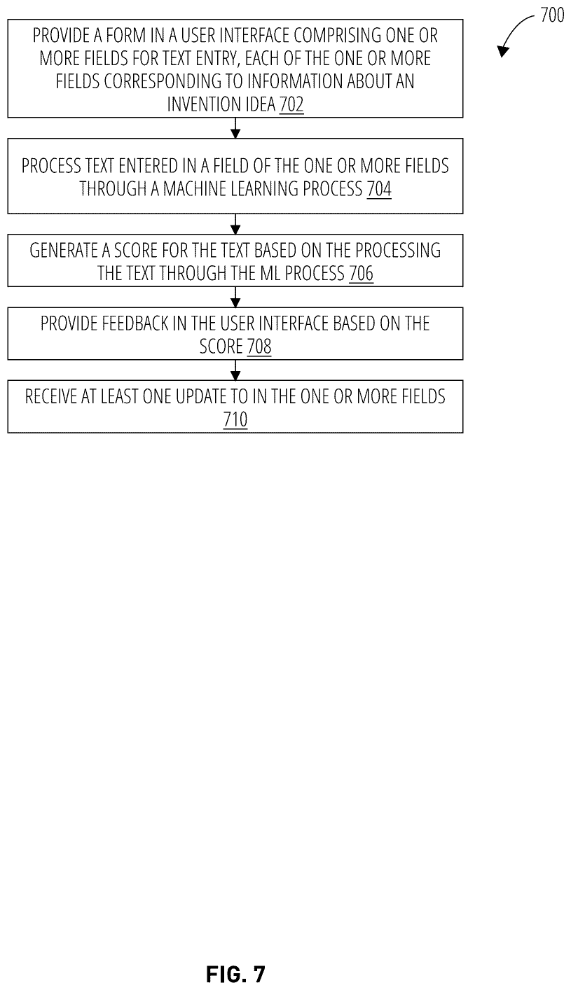

In embodiments, the feedback service 216 provides a disclosure form via the user interface 206 to enter invention details. The inventor begins filling out sections of the invention disclosure. The sections may include title, problem, solution, prior art, description, summary/abstract, novelty, business value, etc. The patentability system 106 including the feedback service 216 may start to ingest and process the text the inventor is inputting into the form and send it to a real-time Al processing component of the analysis service 214. The user interface 206 may provide and the analysis service 214 may analyze the ingestion on a cadence, after clicking out of a box, when a number of words or characters are provided, etc. As discussed in FIGS. 7, and 8A-8C, the patentability system 106 may process the information from a field through a model and utilize embeddings of the input information and a corpus of documents, e.g., prior art, to identify clarity issues and novel aspects to generate prompts for additional information. The analysis service 214 may generate a response or prompt based on scoring to provide to the inventor in real time. The response is then returned to the invention disclosure form via user interface 206 to provide to the inventor. The user interface 206 may show animated elements to show the Al processing. The user interface 206 may highlight to the inventor the Al response provided by the analysis service 214. The inventor may utilize the feedback to update their disclosure. The Al may suggest that the disclosure is in a quality state and the inventor hits submit. The Al may suggest the disclosure needs updates, which the inventor ignores.

The feedback service 216 assists inventors in crafting high-quality disclosure forms for their patent applications. It provides an interactive user interface 206 on the business system 102 that allows inventors to input detailed information about their innovation into various sections, such as title, problem, solution, prior art, description, summary/abstract, novelty, and business value. Once the inventor fills out these sections using the user interface 206, the feedback service 216 actively monitors the text input in real-time. It sends this information to a real-time Al processing component of the analysis service 214 for further examination and evaluation. In some instances, the analysis service 214 processes the inventor's disclosure on an automated cadence. In other instances, the analysis service 214 processes the inventor's input after completing each section or upon reaching specific word or character thresholds.

As the text is being analyzed, the Al processing component generates a response that includes insights and scores reflecting the quality of the disclosure form. This real-time feedback or prompts is then returned to the inventor via the user interface 206, allowing them to review and utilize these suggestions for improving their submission. The user interface 206 may also include animated elements visually representing the ongoing Al processing. These animations can help emphasize important feedback or highlight areas where further attention is needed from the inventor.

In cases where the analysis service 214 identifies potential issues with the disclosure form, such as lack of clarity or similarity to the prior art, it may promptly notify the inventor by distinctively marking these sections within the user interface 206. This immediate feedback empowers inventors to make timely revisions and updates to their submissions, enhancing the quality and effectiveness of their patent applications.

Ultimately, the feedback service 216 plays an integral role in helping inventors create comprehensive and clear disclosure forms that meet the rigorous standards required for successful patent examination. By providing real-time insights and scores based on cutting-edge Al processing techniques, it enables inventors to refine their submissions while navigating complex technical landscapes confidently.

The patentability system 106 incorporates sophisticated mechanisms to ensure the highest quality of disclosure forms submitted for examination. One such feature is its ability to prevent submissions from being processed if they fall below a predefined score threshold or until specific issues highlighted by Al-generated comments are adequately addressed.

The patentability system 106 employs an intelligent scoring algorithm that assigns individual scores for various aspects of the disclosure form, such as clarity, novelty, and distinction from prior art. Some Al comments may carry different weights or importance based on their impact on overall quality; these varying scores help inventors understand which areas require immediate attention to improve their submissions' chances of approval.

In some instances, patentability system 106 allows an inventor to override its automatic submission prevention and continue with their application process. However, this override feature could potentially lead to lower-quality disclosures being examined by patent offices and may be disabled. When an inventor attempts to address Al comments, the patentability system 106 via inputs into the user interface 206 captures the updated text. It is sent back to the Al component of the analysis service 214 for reevaluation. This iterative process ensures that any modifications made in response to feedback improve the quality of the disclosure form. The Al component of the analysis service 214 analyzes new and previously unchanged text sections to determine whether the inventor has effectively addressed all outstanding comments. By meticulously tracking these revisions, the patentability system 106 provides a transparent and accountable path for inventors to enhance their submissions. This iterative feedback loop between the inventor and Al component fosters an environment where continuous improvement is encouraged, ultimately leading to higher-quality disclosure forms that stand up to rigorous examination by patent authorities.

In embodiments, the analysis service 214 performing AI operations may be configured before processing disclosure text. The analysis service 214 may initially receive one or more of the following, Al initialization, a description of the role/identity of the Al, a description of the task for the Al, requirements for the Al to fulfill, etc.

In embodiments, the analysis service 214 performs Al initialization, including setting up and fine-tuning an AI model to prepare it for analysis tasks specific to a particular disclosure or newly identified idea. During initialization, various parameters, such as learning rates, activation functions, and neural network architectures, may be adjusted based on the characteristics of past analyses or industry benchmarks. The analysis service 214 may determine a role and identity description. The Al service is provided with information about its role within the larger system-whether it acts as a predictive model, classifier, or anomaly detector. Additionally, identifying any unique traits related to specific types of inventions or industries can help tailor the AI's analysis capabilities more effectively. The analysis service 214 may determine and utilize transformers and language models pre-trained on extensive patent data sets. The analysis service 214 also receives explicit instructions about its assigned task—be it analyzing novelty, identifying prior art references, and/or evaluating the overall quality of a disclosure form. This might include specific objectives such as detecting instances of non-obviousness, improving clarity and conciseness in language usage, or ensuring that the description well supports claims. The analysis service 214 is also informed about any requirements it needs to fulfill when processing disclosure forms. These could range from adhering to regulatory guidelines for patent documentation, maintaining confidentiality of sensitive information, or ensuring compliance with specific legal standards in different jurisdictions. Configuring the analysis service 214 appropriately before analyzing each unique disclosure form can provide accurate and relevant feedback to inventors while adhering to industry-specific requirements and maintaining a high standard of quality throughout its operations.

The analysis service 214, when processing the text, may also take into account and configured to take into account various contextual and historical aspects to provide an in-depth evaluation. The analysis service 214 can be configured with information related to the disclosure and its evolution. For example, the analysis service 214 analyzes both new and old sections of a disclosure form, distinguishing between them for accurate assessment when processing text. By identifying newly added or modified text, the analysis service 214 can focus and process changes made by the inventor since the last review, enabling precise feedback on improvements or potential issues introduced in those updates. The analysis service 214 also incorporates information from prior art searches conducted during the examination process to determine if any existing patents or publications could impact the novelty of a disclosure form. This involves cross-referencing claims and descriptions against global intellectual property records databases, providing inventors with valuable insights into potential infringement risks. The analysis service 214 may also classify information within the disclosure forms based on their relevance to various aspects of patentability-such as novelty, non-obviousness, and sufficiency of disclosure. The analysis service 214 also generates summaries that consolidate key points from the disclosure for inventors' reference or review by legal counsel. Written in plain language, these summaries help inventors quickly grasp their application's strengths and weaknesses without delving into complex technical details.

In embodiments, the analysis service 214 is configured to track the number of times an inventor has updated their disclosure form, which can be crucial in understanding the iterative process of refining a patent application. This information helps identify patterns or recurring issues that may need addressing and provides context for changes made over time. Further, by analyzing previous responses provided by inventors, such as feedback from Al's initial assessment or input from legal advisers, the analysis service 214 can build a comprehensive understanding of an application's trajectory. This historical context allows for more nuanced recommendations and can help predict potential challenges based on past experiences.

Finally, the analysis service 214 may determine information about the law firm handling the disclosure form, as it may influence the approach to patent prosecution and strategy. Different firms have various specializations, resources, and networks that can affect how a disclosure form is presented and defended during examination proceedings. By integrating these diverse data points into its analysis framework, the analysis service 214 provides inventors with an all-encompassing evaluation of their patent applications, enabling them to make informed decisions throughout the prosecution process while ensuring compliance with legal standards and industry best practices.

The feedback service 216, to perform the AI operations, may acquire additional information about the disclosure before generating a response including classification of the disclosure. In some instances, the 216 determines the prior art nearest to the patent via description of the invention via the disclosure form, via ML lookup, embedding distance search or clustering search, topic analysis, keyword lookup, classification enhancement to the above, Z-score enhancement to the above distances for determining critical nature of the prior art, and so forth.

The analysis service 214 can perform additional processing techniques to enhance the processing capabilities further. For example, the analysis service 214 process data using Natural Language Understanding (NLU) to interpret the nuances and context within patent disclosure forms. This includes recognizing idiomatic expressions, technical jargon, and industry-specific language to ensure accurate and relevant feedback. The analysis service 214 can also utilize predictive analytics algorithms to forecast potential outcomes based on historical data. By analyzing patterns in patent examination results and inventor responses over time from the data repository 916, the analysis service 214 can provide early warnings about possible rejections or challenges.

In some embodiments, the analysis service 214 deploys machine learning models that adapt to individual inventors' styles of writing and disclosure content by training on previously submitted disclosures of inventive ideas, which allows the analysis service 214 to tailor feedback more personally. This personalized approach could lead to higher engagement from inventors, as they receive guidance that aligns with their unique application needs.

In some instances, the analysis service 214 manages documents throughout the patent prosecution process by storing information in a data store for each disclosure. For example, the analysis service 214 tracks revisions, maintains version control and ensures all communication is documented for legal purposes, thereby streamlining inventors' workflows and reducing administrative burdens.

Further, the analysis service 214 integrates directly with patent databases, via APIs, such that the analysis service 214 can provide real-time updates on new filings or changes in existing patents that might affect an inventor's disclosure form. This proactive approach ensures that the analysis service 214 and inventors know developments that could impact their intellectual property strategy and modeling techniques. In some instances, the analysis service 214 implements an interactive feedback mechanism whereby the analysis service 214 generates and deploys clarifying questions or requests additional information via the user interface 206 when it encounters ambiguous content, which would significantly enhance its analysis accuracy. The analysis service 214 enables a user-centric approach, ensuring inventors are actively involved in refining their disclosure forms and that any uncertainties are addressed promptly. By incorporating these advanced features, the analysis service 214 becomes an even more powerful tool for inventors, providing them with comprehensive support throughout the complex landscape of patent prosecution.

The analysis service 214 identifies and provides prior art references in some instances. The analysis service 214 also employs a prior art filtering process, which is an essential feature that aids inventors in identifying and understanding the potential impact of existing patents on their own disclosures. The analysis service 214 first determines which prior art references are deemed critical based on various factors such as claim breadth, similarity to the invention's claims (Euclidian distance, etc.), and the likelihood of being cited by patent examiners or used against a patent in litigation based on closeness to the newly identified idea. The analysis service 214 categorizes identified prior art into high, medium, and low relevance tiers according to their potential impact on the novelty and inventiveness of the disclosure's claims. High-relevance references are those with a direct bearing on key aspects of the invention, while lower relevance may still inform broader patent strategy but require less immediate attention. The analysis service 214 may determine the relevance of the reference based on keyword matching, Cosine Similarity scoring, Euclidean Distance, Jaccard Similarity, etc.

The analysis service 214 further applies quantitative constraints to manage its analysis scope effectively. For instance, the analysis service 214 limits high-relevance prior art references to a maximum of documents (e.g., five) and medium or low-relevance references to up to a number documents (e.g., three) each. This ensures that the inventor receives focused feedback without being overwhelmed by excessive references. The analysis service 214 also extracts pertinent text segments from selected prior art documents from the filtered set to perform a detailed comparison with the invention's disclosure form. This includes analyzing claim language and descriptions within these excerpts to identify potential overlaps or novel contributions made by the invention. The analysis service 214 can dynamically adjust its filtering parameters based on inventor input and updates in prior art databases. This responsiveness ensures that the analysis remains current and relevant to changing circumstances. Further, analysis service 214 filtering process is designed to comply with legal standards for determining the sufficiency of prior art, such as those outlined by patent offices worldwide, e.g., filing date, first-to-file, and other patenting requirements. By adhering to these guidelines, inventors can be confident that their disclosures are being evaluated in a manner consistent with official practices and expectations. By employing these advanced filtering processes, the analysis service 216 provides inventors with an intelligently curated set of prior art references that have been assessed for criticality and relevance to their patent application claims. This enables inventors to make informed decisions about claim amendments or strategic planning while ensuring a high level of precision in the analysis provided by the AI system.

In some instances, the patentability system 106 can undertake various actions involving a disclosure. This may include transmitting the disclosure to an appropriate authority for review, such as a business manager, patent manager, portfolio manager, or attorney. Additionally, it may involve assigning this disclosure to a legal professional and prompting them to compose a patent application.

The patentability system 106 can automatically decide on which law firm, patent agent, or attorney will handle the task based on various factors. These factors might include anticipated classification of the invention, proximity to prior art, nearest previous intellectual property disclosures (IDFs) dealt with by different legal entities, and even classifications assigned to these IDFs previously managed by law firms. Moreover, incorporating feedback from attorneys regarding past cases can also contribute to the patentability system's 106 decision-making process. The significance of selecting a suitable law firm, patent agent, or attorney is that previous inventors have reported positive outcomes when receiving tailored advice and services based on their specific needs and circumstances. This personalized approach increases the likelihood of obtaining a successful patent for an inventor's intellectual property.

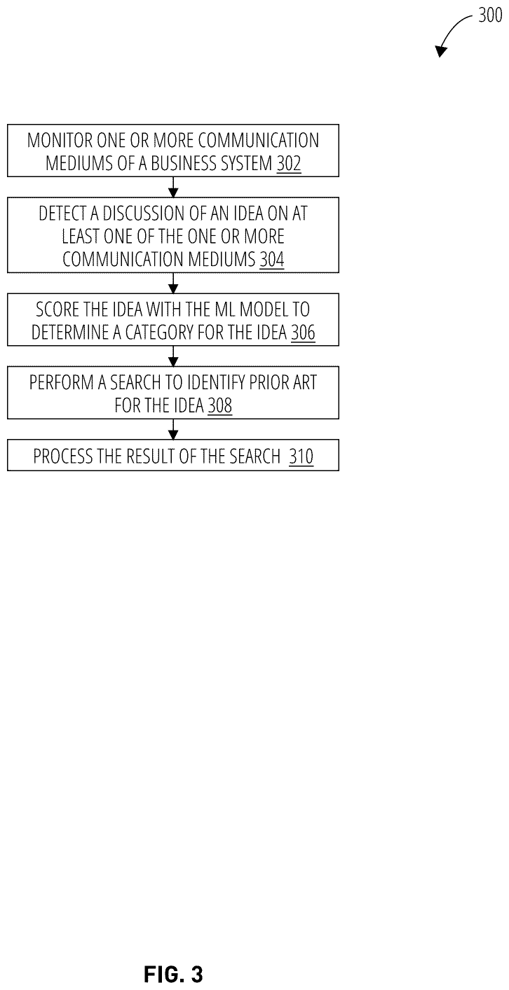

FIG. 3 presents a conceptual diagram depicting routine 300, an automated process designed to identify potentially patentable ideas during everyday discussions on business systems. The illustrated routine encompasses several critical steps.

In block 302 of the FIG. 3, routine 300 is configured to monitor a range of communication mediums—this could include email inboxes, enterprise messaging applications like Slack or Microsoft Teams, project management tools such as Trello or Asana, and company-wide discussion forums. The aim is to capture conversations that may contain new ideas or innovations relevant to the organization's intellectual property portfolio.

In block 304 of FIG. 3 indicates a detection phase where routine 300 analyzes these monitored communications. It employs natural language processing (NLP) or machine learning techniques to discern patterns, keywords, or phrases that signify the initiation of discussions around new ideas—these could be technical terms, project references, or innovative concepts shared by employees.

The process progresses into block 306, where routine 300 applies a machine learning model to score and categorize these identified ideas. In some instances, if the system cannot categorize, e.g., determine the idea is new/novel, the system may continue to monitor the one or more communications channels until the scoring indicates the idea can be categorized. Further and at block 308, routine 300 conducts a comprehensive search to find any existing prior art associated with the discussed idea. The system searches global databases like Google Patents, IEEE Xplore, and WIPO's PATENTSCOPE, as well as local repositories managed by businesses or research institutions, ensuring that no relevant information is overlooked.

Finally, in block 310, routine 300 processes the results of both the idea scoring and prior art search to make informed decisions regarding each identified concept's viability for patenting or other forms of IP protection. This processing may involve generating disclosure reports flagging ideas for human review, recommending next steps, requesting additional information from inventors, and/or initiating a filing sequence if deemed appropriate. FIG. 3 serves as an illustrative guide to the mechanics behind routine 300-a sophisticated and integral system that streamlines the identification of valuable intellectual property within a business's daily communications.

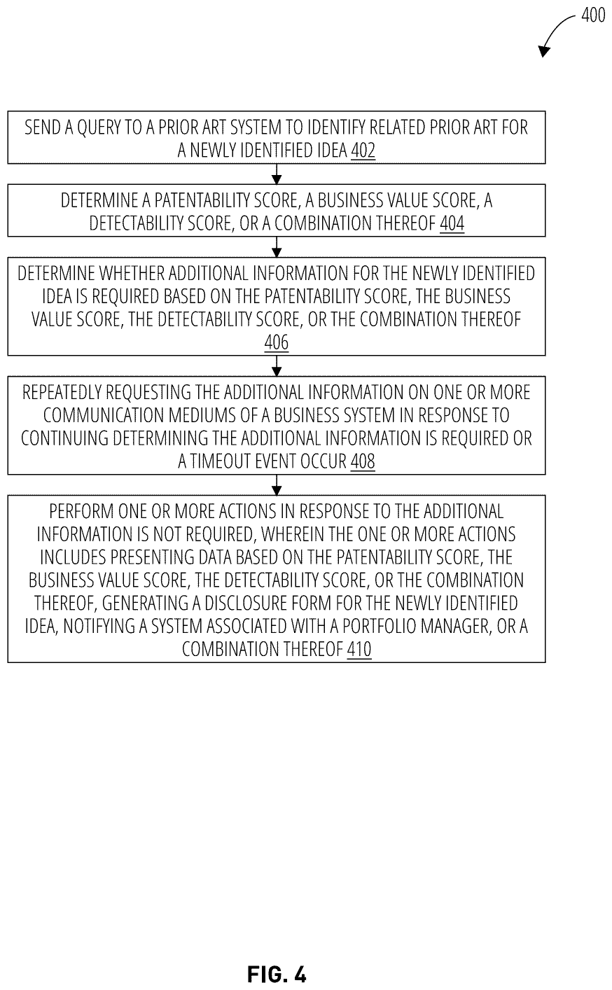

FIG. 4 provides a visual representation of routine 400, an advanced system designed to evaluate newly identified ideas by analyzing various factors that contribute to their potential success and patentability. The detailed workflow outlined in FIG. 4 includes, at block 402, routine 400 initiates a query into one or more prior art systems—such as comprehensive databases like Google Patents, EPO Espacenet, and the USPTO's PATFT (Patent Full-Text Database)—to search for existing documents that may preemptively impact the novelty of the idea.

In block 404, routine 400 employs a multi-criteria scoring mechanism to assign scores across different domains—patentability (based on factors like novelty and non-obviousness), business value (reflecting the potential commercial impact of the idea), and detectability (measuring how easily an idea can be identified within prior art). These scores are pivotal in guiding decision-making processes, such as whether to pursue a patent application or not.

The subsequent block, 406, involves evaluating these scores alone or collectively to determine the need for additional information. If one or more scores are low (below a threshold value), indicating potential issues with patentability, business value, or detectability, routine 400 flags that more data may be required—this could include a deeper analysis of prior art references, further discussions on the idea's commercial implications, or enhanced technical descriptions to clarify its uniqueness.

At block 408, routine 400 dynamically adjusts its approach based on whether additional information is needed or if it encounters a timeout event-such as an inability to access the necessary data within a reasonable timeframe. In response to this need for more details, routine 400 may send out requests across various communication channels used by the organization, like emails, project management tools, and intranet posts, ensuring that relevant stakeholders are kept informed and engaged in the process.

Finally, block 410 represents the culmination of routine 400's assessment. Should additional information not be necessary-perhaps due to satisfactory scores across all evaluated domains—routine 400 proceeds by compiling a comprehensive report that encapsulates the idea's patentability, business value, and detectability scores for internal review or strategic planning. In addition or alternatively, it may generate a disclosure form tailored to filing a provisional patent application if deemed appropriate. Moreover, routine 400 might alert portfolio managers through notifications on dedicated systems like Anaqua, IPPortal, or an email blast, ensuring that the idea is integrated into strategic business planning and resource allocation effectively. FIG. 4 encapsulates a holistic approach to evaluating new ideas within a company's intellectual property ecosystem-a process designed not only to identify potentially valuable inventions but also to align them with broader business objectives and legal considerations.

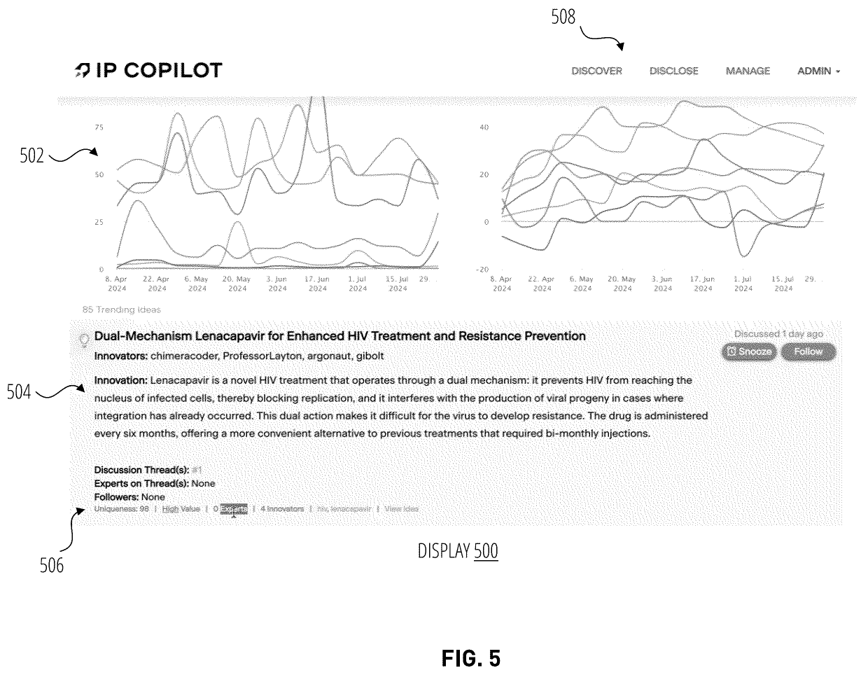

In embodiments, information may be presented to users, such as inventors, patent managers, portfolio managers, patent experts, patent attorneys, business managers, etc., in one or more displays. FIG. 5 provides a display 500 of an example graphical user interface (GUI) that serves as an interactive platform for conveying complex information about emerging ideas to various stakeholders within the organization's intellectual property management framework. In the illustrated example, the display 500 displays information about ideas being discussed within a business system 102. The display 500 includes different sections, such as a trend section 502, a description section 504, a score section 506, and a menu 508.

The trend section 502 presents an at-a-glance visualization of the ideas' performance metrics and sentiment analysis across different time frames. This could be in the form of line graphs or bar charts, where each idea is plotted against a timeline to showcase its growth trajectory, fluctuations, and overall reception within the business environment.

The description section 504 presents an encapsulated view of one specific idea by presenting a succinct summary that includes, a title or name for the invention to provide immediate recognition, and an abstract or synopsis describing the core functionality, novelty, and potential impact of the idea. The 504 may also include a list of related discussion threads wherein stakeholders have been debating various aspects of the concept—an indication of its relevance and interest within the organization, and a count of expert inventors associated with this particular idea or thread, indicating a level of specialized knowledge and contribution that may influence decision-making processes.

The score section 506 quantifies each idea's potential by displaying critical metrics such as patentability scores and/or uniqueness scores-indicators derived from an amalgamation of factors, as discussed above. This section also highlights the number of inventors who have contributed to or are engaged with this idea, and a listing of expert inventors identified based on their track record in the field (evidenced by patents and publications), contributions to other ideas within the portfolio, and their engagement duration—each of these factors playing a role in assessing an idea's credibility and potential value.

Additionally, the menu 508 facilitates user interaction with the GUI by offering various navigation pathways including a Disclosure Section to enable a user to provide a disclosure to prepare for filing patent applications or public disclosures. The menu 508 also includes Discovery Section dedicated to exploring and evaluating new ideas, incorporating search functionalities or idea submission tools. The Manage Section includes modules for tracking the progress of an idea's development, managing collaborations, or assigning tasks related to its advancement. The menu 508 also includes an Admin Section that provides access to administrative controls and settings that govern the overall operation of the business system relating to intellectual property management. By integrating these interactive components into a single GUI display, FIG. 5 demonstrates an advanced approach to knowledge sharing—a vital component in fostering innovation within organizations by ensuring all relevant parties can access timely and actionable information about new ideas under consideration.

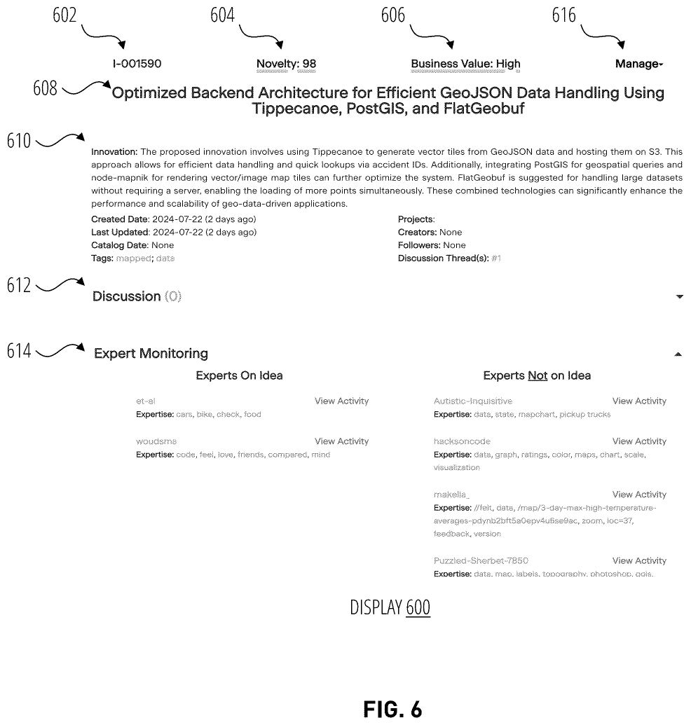

FIG. 6 illustrates another example of a display 600 in accordance with embodiments. Specifically, display 600 includes a GUI including more details of a newly identified idea. The display 600 includes an identifier 602, a patentability score 604, a business value score 606, and a drop down menu 616 at a top portion of the display 600. The identifier 602 may identify the idea. The patentability score 604 and business value score 606 are scores for the idea as discussed herein.

Specifically, the display 600 is structured with several elements that work in concert to deliver a rich and nuanced understanding of each idea. The identifier 602 is an element that serves as a unique identifier for the specific idea being evaluated. The identifier could take various forms, such as a numerical ID, alphanumeric code, or even a descriptive label that distinguishes it from other ideas within the organization's portfolio. The patentability score 604 is a quantified assessment of an idea's eligibility for patent protection based on criteria such as novelty, non-obviousness, and utility, as discussed herein. The score may range from low to high numerical values, with higher values indicating greater potential for obtaining a patent. The business value score 606 is a metric that evaluates an idea's commercial viability and strategic importance to the organization, as discussed herein. It encompasses considerations such as market demand, potential revenue generation, competitive advantage, and alignment with company goals or objectives. In embodiments, each of the considerations may be assigned a numeric value, e.g., a score between 1-10. The system may determine a numeric value for each of the considerations for a newly identified idea, e.g., based on user input or defined characteristics provided to the system. All of the numeric values for each consideration may be added to generate a total business value score. One or more threshold or ranges of values may be identified to assign a “business value,” e.g., low, medium, or high. In embodiments, the ranges may be predefined and/or customizable by a user of the system.

The drop-down menu 616 is also positioned at the top of the display; this interactive component provides a hierarchical navigation path that allows users to access various sections of information related to an idea.

The display 600 provides a comprehensive overview of each idea, showcasing its title 608, a detailed description section 610 that includes a concise summary of the idea, the date it was created, the date it was last modified, relevant catalog data, associated tags, the project identifier, the inventors or creators behind the idea, its followers, and any discussion threads related to it.

The display 600 also includes a discussion section 612 that includes one or more discussions between the users of the system of the idea. The discussion section 612 of display 600 is an essential platform for fostering collaborative engagement and knowledge sharing among users within the organization. It serves as a digital forum where stakeholders can interact, exchange ideas, debate concepts, and work together to refine and develop innovations. In embodiments the discussion section 612 includes discussion threads, e.g., chronological threads of conversation that revolve around the specific idea presented in display 600. Each thread is a collection of user-generated content such as comments, questions, suggestions, and responses. By organizing discussions into separate threads, users can follow conversations about individual aspects or challenges associated with the idea. The discussion section 612 also enables for dynamic user interaction-stakeholders can contribute their insights, ask questions, and provide feedback directly on the central platform where the idea is documented. This direct engagement ensures a more inclusive approach to innovation management and decision-making. As users discuss various facets of an idea, they contribute to its evolution by identifying strengths, weaknesses, opportunities for improvement, or potential applications. This collective intelligence can significantly shape the development trajectory of the concept and ensure that it remains aligned with market needs and technological possibilities. Discussions provide a repository of shared knowledge where users can learn from each other's expertise, experiences, and perspectives. This exchange enriches the collective understanding of the idea and its implications, fostering an environment conducive to learning and professional growth. By bringing together diverse groups within the organization-such as researchers, engineers, marketers, and executives—the discussion section encourages interdisciplinary collaboration that is crucial for complex innovations. It breaks down silos and promotes a culture of open communication where barriers are minimized, and cross-functional teams can work synergistically.

The system allows users to track the history of each discussion thread, including who has contributed, what changes have been made over time, and how ideas have evolved as a result of these conversations. This transparency is key for accountability and understanding the rationale behind decisions or shifts in direction. To maintain productive discussions, there may be moderators who can facilitate conversation, ensure adherence to guidelines, and filter out irrelevant content. They play a crucial role in keeping the discourse focused on value-adding contributions that advance the idea's development. In summary, the discussion section of display 600 is integral for cultivating an interactive ecosystem where ideas are documented and actively debated and developed through collective wisdom and collaborative effort.

The display 600 also includes an expert section 614. The expert section 614 illustrates the experts that have contributed to the ideas based on the discussion, and experts in the area of the idea that have not contributed to the idea. The expert section 614 of display 600 is a strategic addition that acknowledges the significant contributions made by subject matter experts and identifies potential untapped talent within or outside the organization. This segment serves multiple functions showcasing contributors by highlighting individuals who have actively participated in discussions, expert section 614 provides a visual representation of stakeholders directly involved with refining and developing the idea. It offers recognition to their expertise and contributions, which can be motivating for continued engagement and innovation within the organization.

FIG. 7 illustrates an example of a routine 700 in accordance with embodiments. Specifically, the routine 700 is one example of processing that may be performed by a compute system to provide a disclosure form in a GUI, process entries in the form in real-time, provide feedback in prompts to in the GUI, and receive updates.

In block 702, routine 700 provides a form in a user interface (UI) comprising one or more fields for text entry, each of the one or more fields corresponding to information about an invention idea. This UI form serves as a platform for users to input information about their invention ideas. The structure of this form typically includes one or more text entry fields that correspond directly to specific aspects of the disclosed invention. These fields within the UI may include a short description field to enter a description of the idea, a title field, an inventive/conception date(s) field, a inventor field, etc. Other fields may include a problem statement field, proposed solution field, potential applications field, a technical advantage field, a product field, etc. The form provides a structured layout that allows for efficient processing and storage of invention idea information within the computational system, facilitating subsequent steps such as evaluation, ranking, or patent filing procedures. FIGS. 8A-C illustrate an example of a display 800 including a UI presenting one or more fields of a disclosure form.

In block 704, routine 700 processes text entered in a field of the one or more fields through a machine learning model. The system employs this ML model to analyze and evaluate textual input entered by users into any one or more fields within the user interface form. The machine learning model can be configured to perform a text analysis and interpretation. For example, a model can utilize embeddings to look at distances between document(s). The system can then segment the document & generate a new embedding from the combination of embeddings from various sections of the document. The embeddings of various sections can be used to focus on a specific region of a document and content. The identified sections and regions of the document(s) can then be utilized to formulate feedback and prompts to a user during the disclosure form generation. In other instances, a singular model can be used to generate an embedding from a whole document. Routine 700 leverages the ML model to interpret and analyze the content for relevant patterns or insights that may not be immediately apparent through traditional methods.

In other embodiments, the system may utilize a trained model, trained on content and relevant information. This analysis can encompass various aspects such as semantic understanding, context recognition, and sentiment detection. The machine learning model is trained on a comprehensive dataset comprising prior art-a collection of existing inventions, patents, scientific literature, or other documents that precede the user's input text. By leveraging this training data, the ML model can effectively identify similarities or differences between the new invention idea and previously documented concepts within the domain. By integrating a machine learning model into routine 700, the system enhances its ability to evaluate inventions by considering both user-generated content and existing knowledge in the field.

In block 706, routine 700 generates a score for the text based on the processing of the text through an ML model e.g., The model takes the embeddings as input and processes them through its internal layers of the model. The model determines how it uses the embeddings to understand the text's meaning, e.g., identify similarities between the input data from a field, with data from document(s). These scores are instrumental in quantifying both inventive aspects and problem areas within the new idea presented in the user's entry based on different fields of information, e.g., problem field, solution field, etc.

In one example, the scoring analysis includes assessing inventive elements and evaluates the novelty and creativity of the input text by comparing it against a vast repository of document(s) utilizing embeddings. This comparison involves identifying unique features, concepts, or methodologies that differentiate (or similar to) the new idea from existing solutions in the field. The ML model may also identify potential challenges by analyzing weaknesses, gaps, or limitations inherent within the new idea as expressed through the user's text input. This assessment aids in pinpointing areas that may require further development or refinement to enhance its practical applicability and effectiveness. In one example, to objectively measure how closely related the new idea is to the existing prior art, routine 700 calculates similarity metrics such as cosine similarity or Euclidean distance between the input text and text of the prior art or documents. These metrics indicate the degree of resemblance between the text-derived invention and previously documented concepts within the domain. The resulting score generated by routine 700 serves multiple purposes, including prioritization, where inventions with higher scores may be prioritized for further examination or support, as they potentially possess a strong inventive character or novelty value. The score can offer valuable feedback to the user by highlighting areas of innovation and aspects that might require additional attention or improvement. Further, by quantifying similarity metrics, routine 700 facilitates a comparative analysis between new inventions and existing prior art, enabling stakeholders to assess their relative position within the broader landscape of technological advancements.

In block 708, routine 700 provides, by the system, feedback or prompts in the user interface based on the score. In embodiment, the system delivers feedback to the user through a dedicated section within the user interface or within one or more of the fields. This feedback is tailored based on the scores and insights derived from the ML model's analysis of text input related to the disclosure illustrated in FIG. 8A-8C. In one example, the feedback or prompts references specific aspects of the inventive idea that exhibit novel characteristics or significant departures from existing solutions, e.g., based on the similarity analysis and the information provided in a corresponding field. This feedback or prompt underscores potential areas for innovation and emphasizes the value proposition associated with the new invention. In one example, the feedback or prompt may ask for additional information in areas identified as novel based on information provided in a solution field. In another example, the feedback or prompt may ask for additional information in a problem field based on clarity issues identified by the model.

In some instances, the ML model's analysis also identifies prior art resembling or similar to the inventive idea, as indicated by quantifiable metrics such as cosine similarity or Euclidean distance. By presenting this comparative data within the user interface, the system allows users to gauge their invention's alignment with existing solutions and understand its relative position within the broader technological landscape. In embodiments, the system may request information from the user as illustrated in FIGS. 8A-8C, e.g., prompting users via the UI to provide supplementary information that could clarify their invention's scope, potential applications, or underlying principles. This proactive approach ensures comprehensive understanding and facilitates more informed decision-making processes throughout the evaluation of new inventions during the disclosure form generation.

In block 710, routine 700 receives, by the system, at least one update in the one or more fields. In embodiments, the system may provide an interactive feedback loop that enables users to update the information provided in the one or more fields. This iterative process is designed to refine and enhance the disclosure of new inventions based on the insights gained from previous evaluations conducted by the machine learning model. The updates received through this mechanism may encompass various elements, including additional details about the invention's implementation or functionality that were not initially disclosed. This expanded information can help clarify specific aspects of the invention and highlight its unique features. In some cases, users may present comparisons between their new idea and prior art to emphasize differences and distinguish their innovation from existing solutions. These comparative analyses assist in establishing the novelty and non-obviousness of the inventive concept. Users might propose alternative approaches or methodologies that diverge from those presented in prior art. By presenting these alternatives, users can demonstrate how their invention offers a distinct solution to prevalent problems within the field. By incorporating updates based on feedback received through block 710, routine 700 ensures that inventors can access comprehensive and up-to-date information about their disclosures. This iterative process facilitates effective communication of novel ideas and plays a crucial role in the patent examination process by providing clear distinctions between new inventions and existing solutions.

FIG. 8A illustrates an example of a display 800 in accordance with embodiments. The display 800 includes a number of fields for an inventor to perform an initial submission of an invention. The display 800 includes a problem field 802, a solution field 804, an upload field 806, explanation indicators 808a, and a button 810.

FIG. 8A depicts an exemplary user interface display designed explicitly for inventors during the initial submission phase of their invention disclosure process. This visual representation showcases a comprehensive layout comprising various fields and interactive elements that enable users to articulate their ideas effectively while adhering to patent submission protocols. The illustrated display 800 consists of several components, each serving distinct functions.

The problem field 802 section prompts inventors to define the specific problem or challenge they aim to address with their invention. By capturing this information upfront, users can establish a clear context for their ideas and ensure that subsequent disclosures are aligned with identifiable needs within the relevant domain.

The solution field 804 allows inventors to describe their proposed solution or innovation in detail. It offers an opportunity to outline the technical features, mechanisms, and potential benefits of the new idea. A comprehensive description of the solution helps patent examiners evaluate its novelty, non-obviousness, and practical applicability.

The upload field 806 can be used to upload supporting documentation or multimedia content, such as drawings, diagrams, prototypes, or research data related to their invention. These materials provide descriptive and visual aids that enhance the clarity and comprehension of the disclosed information.

The button 810 element serves as the user interface's primary call-to-action button. Pressing this button initiates the submission process, allowing inventors to submit their disclosures for review and the iterative process described above. The display 800, as depicted in FIG. 8A, represents a structured approach to capturing inventive ideas during the initial submission phase, ensuring that users can present their concepts comprehensively and coherently while establishing clear communication channels with patent examiners or researchers involved in assessing new technologies.

The explanation indicators 808a and 808b are positioned strategically throughout the display, these indicators highlight specific areas or elements within users' submissions to draw attention and emphasize key aspects. By directing focus toward critical details, explanation indicators assist inventors in conveying their ideas more effectively. These indicators enable a disclosure form to generated with real-time feedback. In the illustrated example, explanation indicator 808a corresponds and provides feedback for problem field 802, and explanation indicator 808b corresponds and provides feedback for solution field 804. Note that in embodiments, a form may include additional fields and have corresponding explanation indicators, e.g., title field, related art field, public disclosure field, etc.

Explanation indicators 808a and 808b dynamically update in real-time, utilizing data from their respective fields. For example, the system receives inputs directly from the problem field 802 and/or solution field 804. This process involves utilizing a sophisticated model or AI process. The system may utilize embeddings to look at distances between document(s). The system may then segment the document and generate a new embedding from the combination of embeddings from various sections of the document. The incorporation of embeddings allows for sophisticated textual analysis by capturing semantic meaning and relationships within documents. In this context, an embedding refers to a dense vector representation that encapsulates various aspects of a document's content. For the example, the system computes embeddings for individual sections or paragraphs within each document using techniques like word2vec, BERT, or similar language modeling approaches. These embeddings capture semantic nuances and contextual relationships between words and phrases in their respective segments. The system can then evaluate the distances between these individual embeddings to understand the dissimilarities or similarities across different sections of a document. Such distance metrics can provide insights into how thematically diverse or cohesive various parts of the text are, which is valuable for assessing originality and conceptual integration in the new ideas.

In embodiments, the system may then perform a segmented embedding analysis by segmenting documents into their constituent sections and generating a composite embedding from these individual embeddings, the system achieves an aggregate representation that reflects both the unique characteristics of each part and their collective contribution to the document's overall meaning. This synthesized embedding can reveal overarching themes or innovative concepts that may not be apparent when analyzing sections in isolation. This advanced analysis capability, facilitated by embeddings, enables the system to detect ideas/concepts from the problem field 802 or solution field 804 that are in or not in the analyzed documents. The system may generate questions based on the ideas either detected in the documents, or not in the documents, i.e., newly introduced in the problem field 802 or solution field 804. The questions may be presented in corresponding explanation indicator 808a or explanation indicator 808b fields as prompts for additional information.

For example, the system processes the information in the problem field 802, and identifies additional key concepts and their relationships. In one example, the system identifies ambiguous or unclear concepts within the input problem data, prompting the system to request additional clarification from the user for these specific areas. In another example, the system recognizes potentially novel ideas or uncharted territories in the given problem domain, which may warrant further investigation by the user through targeted questions posed as prompts. These prompts may be provided in explanation indicator 808a, and updated in real-time as additional information is provided.

Similarly, the system generates information and prompts for explanation indicator 808b corresponding to solution field 804. This process also involves data processing and analysis using a model to generate relevant prompts for user interaction by performing a similar embedding analysis. These explanation indicators 808 facilitate an interactive problem-solving environment that adapts to evolving information and user needs by providing real-time updates based on the input fields' content.

FIG. 8A illustrates explanation indicators 808a and 808b in an initial state with general prompts. For example, explanation indicator 808a includes prompts like “Explain the problem your invention is addressing” and “Try to consider questions like: —Why does the problem need to be solved?” “—Who is impacted?” “What are alternatives?” and “Using a bulleted list is a good idea.” The explanation indicator 808b includes prompts corresponding to the solution, such as “Please provide a technical description of the invention, preferably in a bulleted list,” “Be as specific as possible.” “Explain all technical jargon,” and “Emphasize the novel concepts of your invention.”

FIG. 8B illustrates display 800 after information is entered into problem field 802. In this display, the explanation indicator 808a is updated in real-time based on the information entered into problem field 802. The explanation indicator 808a includes updated prompts generated using AI based on the information in the problem field 802. The explanation indicator 808a serves as a dynamic interface that continuously refines its functionality by integrating AI-generated prompts. These prompts emerge from the embedding analysis performed on data residing within the problem field 802 and is updated when new information is added, e.g., in response to a prompt.

Similarly, FIG. 8C illustrates display 800 with newly generated prompts in explanation indicator 808b corresponding to the solution field 804. The explanation indicator 808b is also updated in real-time using AI in a similar process discussed for explanation indicator 808a. However, the system processes the solution information entered in the solution field 804 to generate prompts for 808b in real-time.

In some instances, the system may generate prompts for the explanation indicators 808 for information to build a disclosure form using a trained model or a RAG system. For example, the system employs a pre-trained model, which has been fine-tuned on patent and non-patent documentation to understand the context and structure of the new idea. The system can apply the trained model on text from a field to generate prompts that request specific information for an associated field based on patterns it has learned from the extensive data it's trained. Alternatively, the system might employ a RAG approach to produce relevant content for the disclosure form dynamically. By combining retrieval of existing literature and generation capabilities, the RAG system can propose prompts that guide users in identifying pertinent information from various sources. These generated prompts help ensure comprehensive coverage of all necessary elements within a disclosure document. The output of these systems prompts users to fully develop and draft their disclosures, ensuring that they include critical information such as descriptions of inventions, background, and technical details.

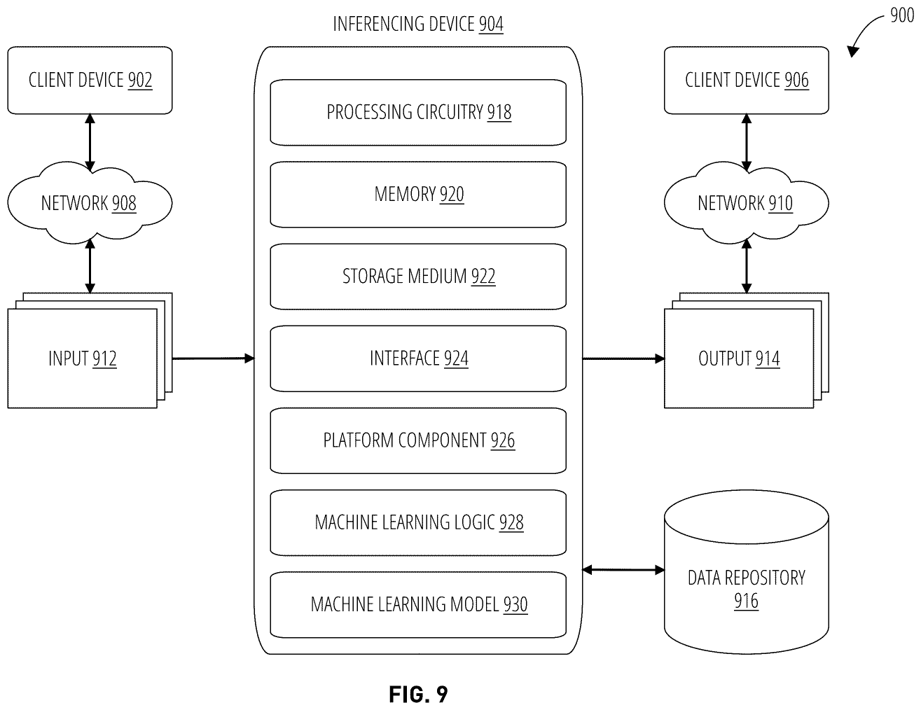

FIG. 9 illustrates an embodiment of a system 900. The system 900 is suitable for implementing one or more embodiments as described herein. In one embodiment, for example, the system 900 is an AI/ML system suitable for performing invention discovery and/or form feedback during invention disclosure form generation.

The system 900 comprises a set of M devices, where M is any positive integer. FIG. 9 depicts three devices (M=3), including a client device 902, an inferencing device 904, and a client device 906. The inferencing device 904 communicates information with the client device 902 and the client device 906 over a network 908 and a network 910, respectively. The information may include input 912 from the client device 902 and output 914 to the client device 906, or vice-versa. In one alternative, the input 912 and the output 914 are communicated between the same client device 902 or client device 906. In another alternative, the input 912 and the output 914 are stored in a data repository 916. In yet another alternative, the input 912 and the output 914 are communicated via a platform component 926 of the inferencing device 904, such as an input/output (I/O) device (e.g., a touchscreen, a microphone, a speaker, etc.).

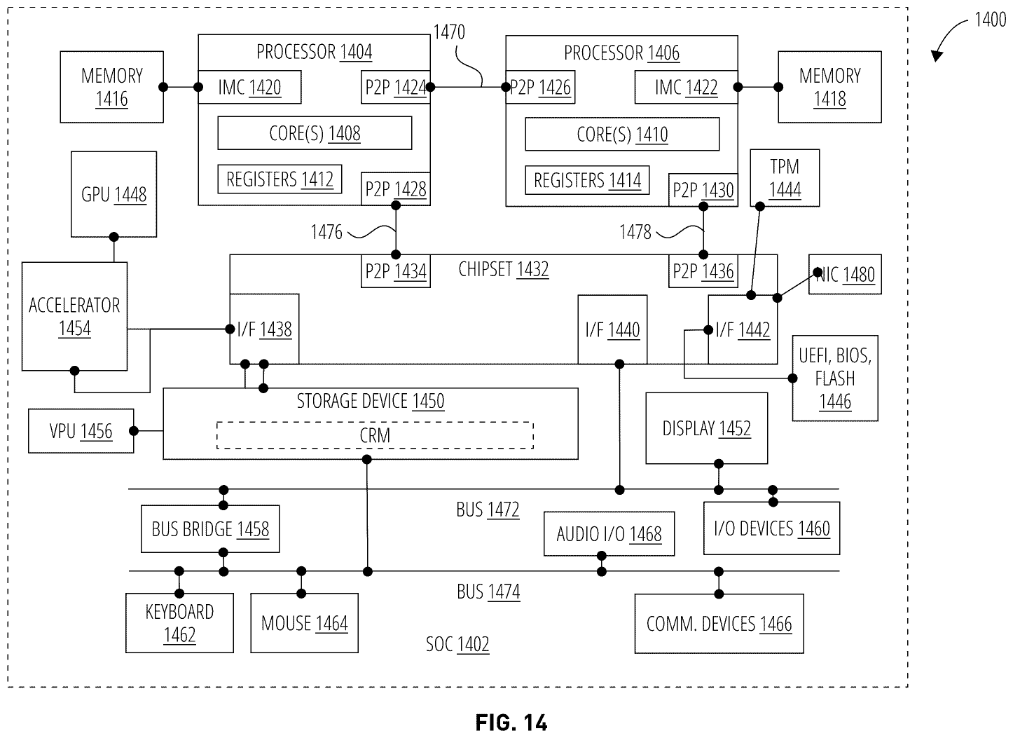

As depicted in FIG. 9, the inferencing device 904 includes processing circuitry 918, a memory 920, a storage medium 922, an interface 924, a platform component 926, ML logic 928, and an ML model 930. In some implementations, the inferencing device 904 includes other components or devices as well. Examples for software elements and hardware elements of the inferencing device 904 are described in more detail with reference to a computing architecture 1400 as depicted in FIG. 14. Embodiments are not limited to these examples.

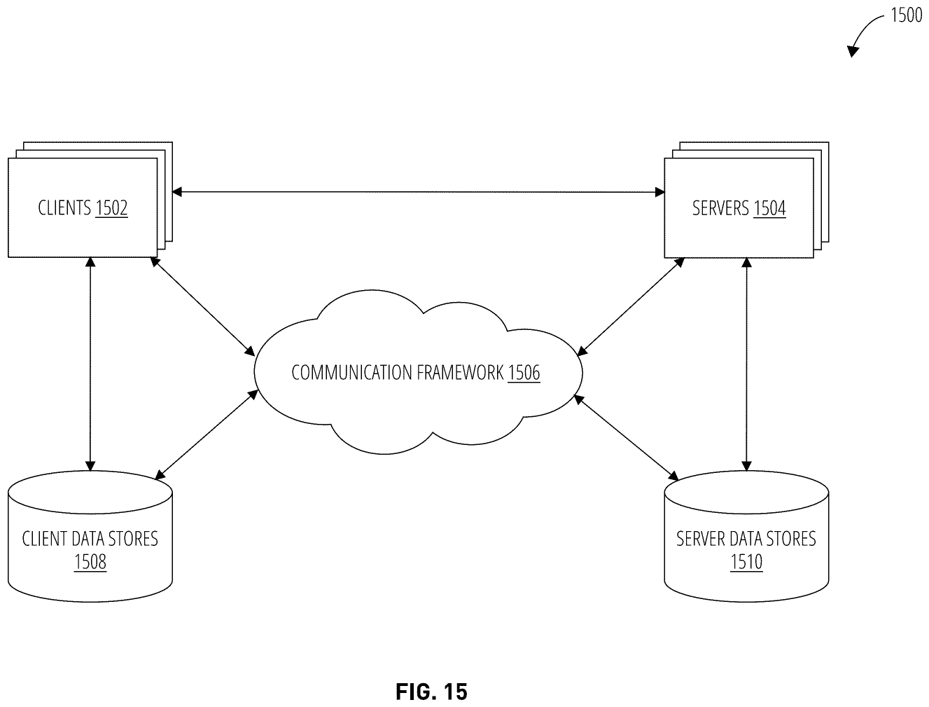

The inferencing device 904 is generally arranged to receive an input 912, process the input 912 via one or more AI/ML techniques, and send an output 914. The inferencing device 904 receives the input 912 from the client device 902 via the network 908, the client device 906 via the network 910, the platform component 926 (e.g., a touchscreen as a text command or microphone as a voice command), the memory 920, the storage medium 922 or the data repository 916. The inferencing device 904 sends the output 914 to the client device 902 via the network 908, the client device 906 via the network 910, the platform component 926 (e.g., a touchscreen to present text, graphic or video information or speaker to reproduce audio information), the memory 920, the storage medium 922 or the data repository 916. Examples for the software elements and hardware elements of the network 908 and the network 910 are described in more detail with reference to a communications architecture 1500 as depicted in FIG. 15. Embodiments are not limited to these examples.

The inferencing device 904 includes ML logic 928 and an ML model 930 to implement various AI/ML techniques for various AI/ML tasks. The ML logic 928 receives the input 912, and processes the input 912 using the ML model 930. The ML model 930 performs inferencing operations to generate an inference for a specific task from the input 912. In some cases, the inference is part of the output 914. The output 914 is used by the client device 902, the inferencing device 904, or the client device 906 to perform subsequent actions in response to the output 914.

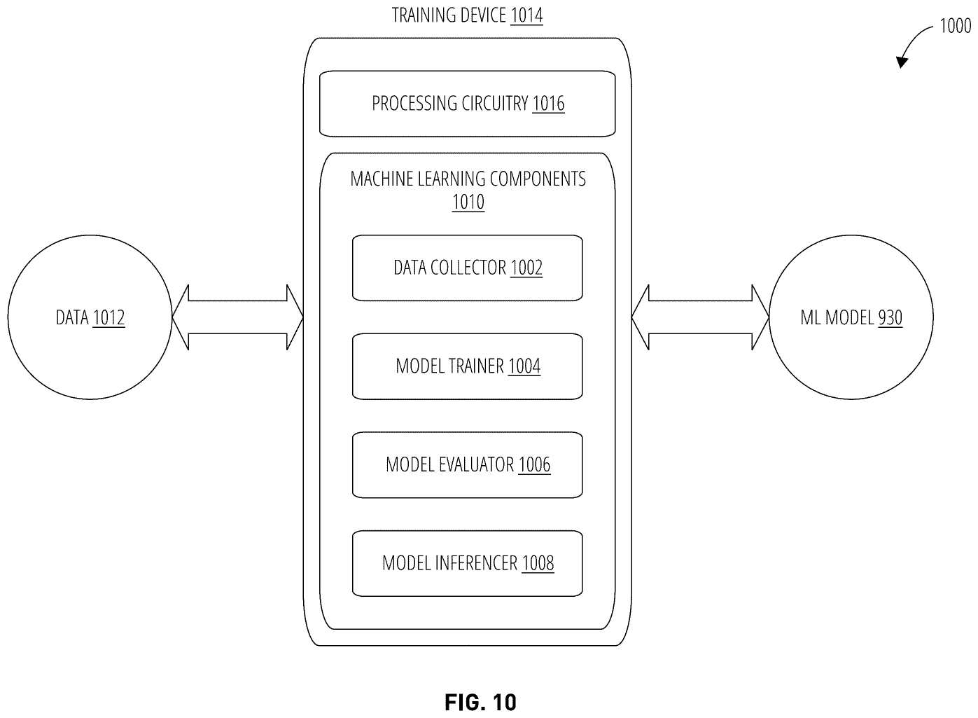

In various embodiments, the ML model 930 is a trained ML model 930 using a set of training operations. An example of training operations to train the ML model 930 is described with reference to FIG. 10.

FIG. 10 illustrates an apparatus 1000. The apparatus 1000 depicts a training device 1014 suitable to generate a trained ML model 930 for the inferencing device 904 of the system 900. As depicted in FIG. 10, the training device 1014 includes a processing circuitry 1016 and a set of ML components 1010 to support various AI/ML techniques, such as a data collector 1002, a model trainer 1004, a model evaluator 1006 and a model inferencer 1008.

In general, the data collector 1002 collects data 1012 from one or more data sources (prior art systems) to use as training data for the ML model 930. The data collector 1002 collects different types of data 1012, such as text information, audio information, image information, video information, graphic information, and so forth from prior art repositories 222, for example. The model trainer 1004 receives as input the collected data and uses a portion of the collected data as test data for an AI/ML algorithm to train the ML model 930. The model evaluator 1006 evaluates and improves the trained ML model 930 using a portion of the collected data as test data to test the ML model 930. The model evaluator 1006 also uses feedback information from the deployed ML model 930. The model inferencer 1008 implements the trained ML model 930 to receive as input new unseen data, generate one or more inferences on the new data, and output a result such as an alert, a recommendation or other post-solution activity.

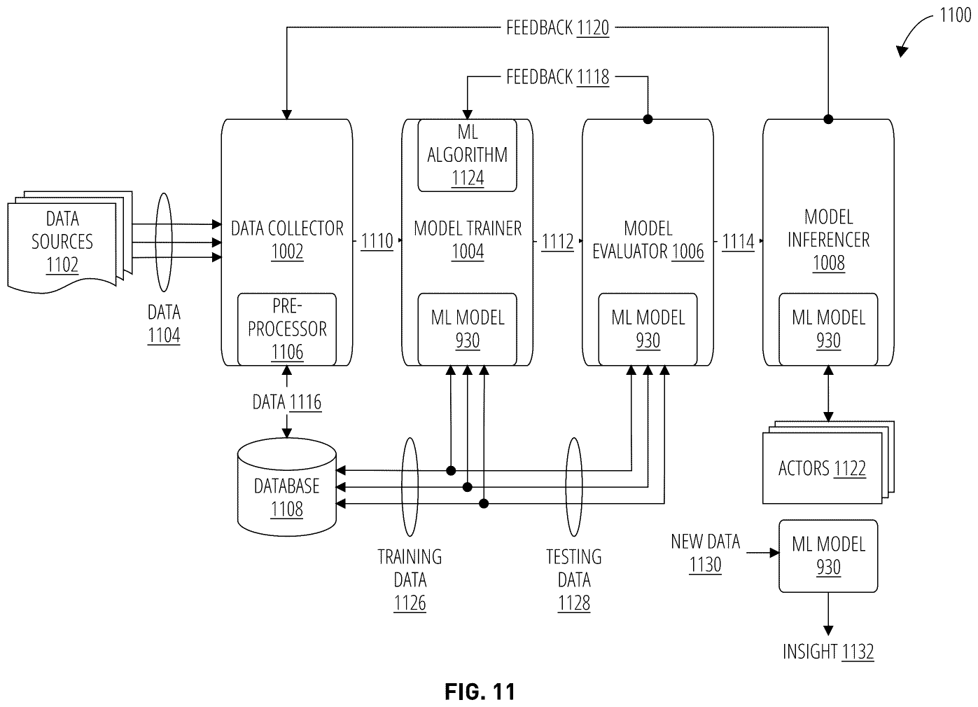

An exemplary AI/ML architecture for the ML components 1010 is described in more detail with reference to FIG. 11.

FIG. 11 illustrates an artificial intelligence architecture 1100 suitable for use by the training device 1014 to generate the ML model 930 for deployment by the inferencing device 904. The artificial intelligence architecture 1100 is an example of a system suitable for implementing various AI techniques and/or ML techniques to perform various inferencing tasks on behalf of the various devices of the system 900.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1100 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 930, evaluate performance of the trained ML model 930, and deploy the tested ML model 930 as the trained ML model 930 in a production environment, and continuously monitor and maintain it.

The ML model 930 is a mathematical construct used to predict outcomes based on a set of input data. The ML model 930 is trained using large volumes of training data 1126 (prior art), and it can recognize patterns and trends in the training data 1126 to make accurate predictions. The ML model 930 is derived from an ML algorithm 1124 (e.g., a neural network, decision tree, support vector machine, etc.). A data set is fed into the ML algorithm 1124 which trains an ML model 930 to “learn” a function that produces mappings between a set of inputs and a set of outputs with a reasonably high accuracy. Given a sufficiently large enough set of inputs and outputs, the ML algorithm 1124 finds the function for a given task. This function may even be able to produce the correct output for input that it has not seen during training. A data scientist prepares the mappings, selects and tunes the ML algorithm 1124, and evaluates the resulting model performance. Once the ML logic 928 is sufficiently accurate on test data, it can be deployed for production use.

The ML algorithm 1124 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1124 of the artificial intelligence architecture 1100 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 11, the artificial intelligence architecture 1100 includes a set of data sources 1102 to source data 1104 for the artificial intelligence architecture 1100. Data sources 1102 may comprise any device capable generating, processing, storing or managing data 1104 suitable for a ML system. Examples of data sources 1102 include without limitation databases, web scraping, sensors and Internet of Things (IoT) devices, image and video cameras, audio devices, text generators, publicly available databases, private databases, and many other data sources 1102. The data sources 1102 may be remote from the artificial intelligence architecture 1100 and accessed via a network, local to the artificial intelligence architecture 1100 an accessed via a network interface, or may be a combination of local and remote data sources 1102.

The data sources 1102 source difference types of data 1104. By way of example and not limitation, the data 1104 includes structured data from relational databases, such as customer profiles, transaction histories, or product inventories. The data 1104 includes unstructured data from websites such as customer reviews, news articles, social media posts, or product specifications. The data 1104 includes data from temperature sensors, motion detectors, and smart home appliances. The data 1104 includes image data from medical images, security footage, or satellite images. The data 1104 includes audio data from speech recognition, music recognition, or call centers. The data 1104 includes text data from emails, chat logs, customer feedback, news articles or social media posts. The data 1104 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1104 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1102 are communicatively coupled to a data collector 1002. The data collector 1002 gathers relevant data 1104 from the data sources 1102. Once collected, the data collector 1002 may use a pre-processor 1106 to make the data 1104 suitable for analysis. This involves data cleaning, transformation, and feature engineering. Data preprocessing is a critical step in ML as it directly impacts the accuracy and effectiveness of the ML model 930. The pre-processor 1106 receives the data 1104 as input, processes the data 1104, and outputs pre-processed data 1116 for storage in a database 1108. Examples for the database 1108 includes a hard drive, solid state storage, and/or random access memory (RAM).

The data collector 1002 is communicatively coupled to a model trainer 1004. The model trainer 1004 performs AI/ML model training, validation, and testing which may generate model performance metrics as part of the model testing procedure. The model trainer 1004 receives the pre-processed data 1116 as input 1110 or via the database 1108. The model trainer 1004 implements a suitable ML algorithm 1124 to train an ML model 930 on a set of training data 1126 from the pre-processed data 1116. The training process involves feeding the pre-processed data 1116 into the ML algorithm 1124 to produce or optimize an ML model 930. The training process adjusts its parameters until it achieves an initial level of satisfactory performance.

The model trainer 1004 is communicatively coupled to a model evaluator 1006. After an ML model 930 is trained, the ML model 930 needs to be evaluated to assess its performance. This is done using various metrics such as accuracy, precision, recall, and F1 score. The model trainer 1004 outputs the ML model 930, which is received as input 1110 or from the database 1108. The model evaluator 1006 receives the ML model 930 as input 1112, and it initiates an evaluation process to measure performance of the ML model 930. The evaluation process includes providing feedback 1118 to the model trainer 1004. The model trainer 1004 re-trains the ML model 930 to improve performance in an iterative manner.

The model evaluator 1006 is communicatively coupled to a model inferencer 1008. The model inferencer 1008 provides AI/ML model inference output (e.g., inferences, predictions or decisions). Once the ML model 930 is trained and evaluated, it is deployed in a production environment where it is used to make predictions on new data. The model inferencer 1008 receives the evaluated ML model 930 as input 1114. The model inferencer 1008 uses the evaluated ML model 930 to produce insights or predictions on real data, which is deployed as a final production ML model 930. The inference output of the ML model 930 is use case specific. The model inferencer 1008 also performs model monitoring and maintenance, which involves continuously monitoring performance of the ML model 930 in the production environment and making any necessary updates or modifications to maintain its accuracy and effectiveness. The model inferencer 1008 provides feedback 1118 to the data collector 1002 to train or re-train the ML model 930. The feedback 1118 includes model performance feedback information, which is used for monitoring and improving performance of the ML model 930.

Some or all of the model inferencer 1008 is implemented by various actors 1122 in the artificial intelligence architecture 1100, including the ML model 930 of the inferencing device 904, for example. The actors 1122 use the deployed ML model 930 on new data to make inferences or predictions for a given task, and output an insight 1132. The actors 1122 implement the model inferencer 1008 locally, or remotely receives outputs from the model inferencer 1008 in a distributed computing manner. The actors 1122 trigger actions directed to other entities or to itself. The actors 1122 provide feedback 1120 to the data collector 1002 via the model inferencer 1008. The feedback 1120 comprise data needed to derive training data, inference data or to monitor the performance of the ML model 930 and its impact to the network through updating of key performance indicators (KPIs) and performance counters.

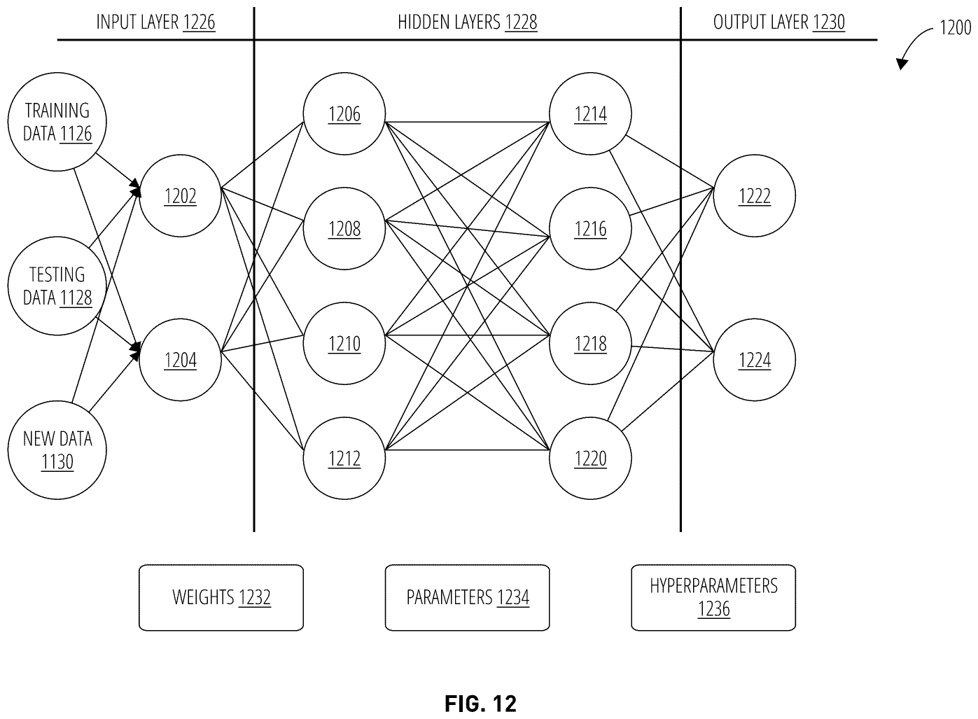

As previously described with reference to FIGS. 1, 2, the systems 900, 1000 implement some or all of the artificial intelligence architecture 1100 to support various use cases and solutions for various AI/ML tasks. In various embodiments, the training device 1014 of the apparatus 1000 uses the artificial intelligence architecture 1100 to generate and train the ML model 930 for use by the inferencing device 904 for the system 900. In one embodiment, for example, the training device 1014 may train the ML model 930 as a neural network, as described in more detail with reference to FIG. 12. Other use cases and solutions for AI/ML are possible as well, and embodiments are not limited in this context.

FIG. 12 illustrates an embodiment of an artificial neural network 1200. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1200 comprises multiple node layers, containing an input layer 1226, one or more hidden layers 1228, and an output layer 1230. Each layer comprises one or more nodes, such as nodes 1202 to 1224. As depicted in FIG. 12, for example, the input layer 1226 has nodes 1202, 1204. The artificial neural network 1200 has two hidden layers 1228, with a first hidden layer having nodes 1206, 1208, 1210 and 1212, and a second hidden layer having nodes 1214, 1216, 1218 and 1220. The artificial neural network 1200 has an output layer 1230 with nodes 1222, 1224. Each node 1202 to 1224 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1200 relies on training data 1126 to learn and improve accuracy over time. However, once the the artificial neural network 1200 is fine-tuned for accuracy, and tested on testing data 1128, the artificial neural network 1200 is ready to classify and cluster new data 1130 at a high velocity. Tasks in speech recognition or image recognition can take minutes versus hours when compared to the manual identification by human experts.

Each individual node 1202 to 424 is a linear regression model, composed of input data, weights, a bias (or threshold), and an output. The linear regression model may have a formula similar to Equation (1), as follows:

$$\sum wixi + bias = w 1 x 1 + w 2 x 2 + w 3 x 3 + bias \qquad EQUATION ( 1 )$$

$$output = f ( x ) = 1 if \sum w 1 x 1 + b >= 0 ; 0 if \sum w 1 x 1 + b < 0$$

Once an input layer 1226 is determined, a set of weights 1232 are assigned. The weights 1232 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1200 as a feedforward network.

In one embodiment, the artificial neural network 1200 leverages sigmoid neurons, which are distinguished by having values between 0 and 1. Since the artificial neural network 1200 behaves similarly to a decision tree, cascading data from one node to another, having x values between 0 and 1 will reduce the impact of any given change of a single variable on the output of any given node, and subsequently, the output of the artificial neural network 1200.

The artificial neural network 1200 has many practical use cases, like image recognition, speech recognition, text recognition or classification. The artificial neural network 1200 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( \hat{{y}_{i}} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1234 of the model adjust to gradually converge at the minimum.

In one embodiment, the artificial neural network 1200 is feedforward, meaning it flows in one direction only, from input to output. In one embodiment, the artificial neural network 1200 uses backpropagation. Backpropagation is when the artificial neural network 1200 moves in the opposite direction from output to input. Backpropagation allows calculation and attribution of errors associated with each neuron 1202 to 1224, thereby allowing adjustment to fit the parameters 1234 of the ML model 930 appropriately.

The artificial neural network 1200 is implemented as different neural networks depending on a given task. Neural networks are classified into different types, which are used for different purposes. In one embodiment, the artificial neural network 1200 is implemented as a feedforward neural network, or multi-layer perceptrons (MLPs), comprised of an input layer 1226, hidden layers 1228, and an output layer 1230. While these neural networks are also commonly referred to as MLPs, they are actually comprised of sigmoid neurons, not perceptrons, as most real-world problems are nonlinear. Trained data 1104 usually is fed into these models to train them, and they are the foundation for computer vision, natural language processing, and other neural networks. In one embodiment, the artificial neural network 1200 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1200 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1200 is implemented as any type of neural network suitable for a given operational task of system 900, and the MLP, CNN, and RNN are merely a few examples. Embodiments are not limited in this context.

The artificial neural network 1200 includes a set of associated parameters 1234. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1200 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1236. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

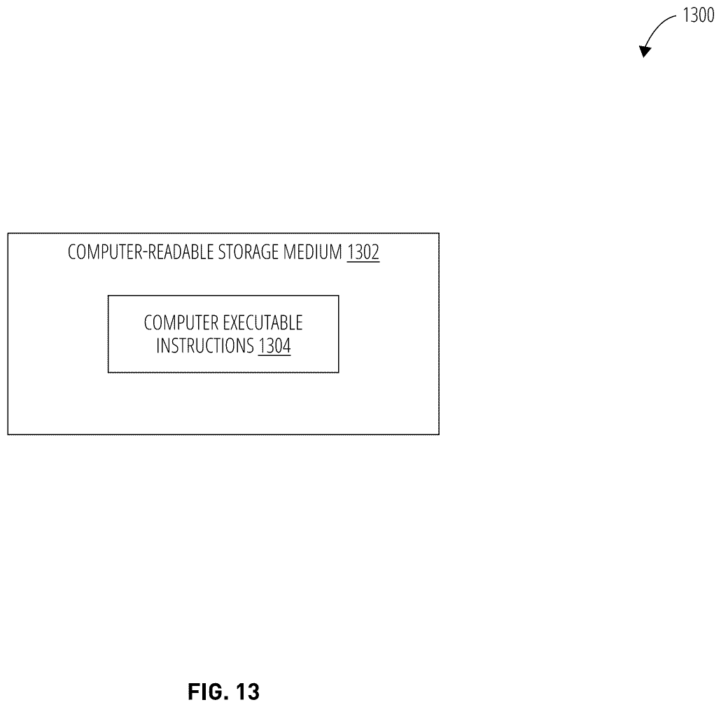

FIG. 13 illustrates an apparatus 1300. Apparatus 1300 comprises any non-transitory computer-readable storage medium 1302 or machine-readable storage medium, such as an optical, magnetic or semiconductor storage medium. In various embodiments, apparatus 1300 comprises an article of manufacture or a product. In some embodiments, the computer-readable storage medium 1302 stores computer executable instructions with which one or more processing devices or processing circuitry can execute. For example, computer executable instructions 1304 includes instructions to implement operations described with respect to any logic flows described herein. Examples of computer-readable storage medium 1302 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1304 include any suitable type of code, such as source code, compiled code, interpreted code, executable code, static code, dynamic code, object-oriented code, visual code, and the like.

FIG. 14 illustrates an embodiment of a computing architecture 1400. Computing architecture 1400 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1400 has a single processor with one core or more than one processor. Note that the term “processor” refers to a processor with a single core or a processor package with multiple processor cores. In at least one embodiment, the computing computing architecture 1400 is representative of the components of the system 900. More generally, the computing computing architecture 1400 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1400. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 14, computing architecture 1400 comprises a system-on-chip (SoC) 1402 for mounting platform components. System-on-chip (SoC) 1402 is a point-to-point (P2P) interconnect platform that includes a first processor 1404 and a second processor 1406 coupled via a point-to-point interconnect 1470 such as an Ultra Path Interconnect (UPI). In other embodiments, the computing architecture 1400 is another bus architecture, such as a multi-drop bus. Furthermore, each of processor 1404 and processor 1406 are processor packages with multiple processor cores including core(s) 1408 and core(s) 1410, respectively. While the computing architecture 1400 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1404 and chipset 1432. Some platforms include additional components and some platforms include sockets to mount the processors and/or the chipset. Furthermore, some platforms do not have sockets (e.g. SoC, or the like). Although depicted as a SoC 1402, one or more of the components of the SoC 1402 are included in a single die package, a multi-chip module (MCM), a multi-die package, a chiplet, a bridge, and/or an interposer. Therefore, embodiments are not limited to a SoC.

The processor 1404 and processor 1406 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1404 and/or processor 1406. Additionally, the processor 1404 need not be identical to processor 1406.

Processor 1404 includes an integrated memory controller (IMC) 1420 and point-to-point (P2P) interface 1424 and P2P interface 1428. Similarly, the processor 1406 includes an IMC 1422 as well as P2P interface 1426 and P2P interface 1430. IMC 1420 and IMC 1422 couple the processor 1404 and processor 1406, respectively, to respective memories (e.g., memory 1416 and memory 1418). Memory 1416 and memory 1418 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1416 and the memory 1418 locally attach to the respective processors (i.e., processor 1404 and processor 1406). In other embodiments, the main memory couple with the processors via a bus and shared memory hub. Processor 1404 includes registers 1412 and processor 1406 includes registers 1414.

Computing architecture 1400 includes chipset 1432 coupled to processor 1404 and processor 1406. Furthermore, chipset 1432 are coupled to storage device 1450, for example, via an interface (I/F) 1438. The I/F 1438 may be, for example, a Peripheral Component Interconnect-enhanced (PCIe) interface, a Compute Express Link® (CXL) interface, or a Universal Chiplet Interconnect Express (UCIe) interface. Storage device 1450 stores instructions executable by circuitry of computing architecture 1400 (e.g., processor 1404, processor 1406, GPU 1448, accelerator 1454, vision processing unit 1456, or the like). For example, storage device 1450 can store instructions for the client device 902, the client device 906, the inferencing device 904, the training device 1014, or the like.

Processor 1404 couples to the chipset 1432 via P2P interface 1428 and P2P 1434 while processor 1406 couples to the chipset 1432 via P2P interface 1430 and P2P 1436. Direct media interface (DMI) 1476 and DMI 1478 couple the P2P interface 1428 and the P2P 1434 and the P2P interface 1430 and P2P 1436, respectively. DMI 1476 and DMI 1478 is a high-speed interconnect that facilitates, e.g., eight Giga Transfers per second (GT/s) such as DMI 3.0. In other embodiments, the processor 1404 and processor 1406 interconnect via a bus.

The chipset 1432 comprises a controller hub such as a platform controller hub (PCH). The chipset 1432 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1432 comprises more than one controller hub such as a chipset with a memory controller hub, a graphics controller hub, and an input/output (I/O) controller hub.

In the depicted example, chipset 1432 couples with a trusted platform module (TPM) 1444 and UEFI, BIOS, FLASH circuitry 1446 via I/F 1442. The TPM 1444 is a dedicated microcontroller designed to secure hardware by integrating cryptographic keys into devices. The UEFI, BIOS, FLASH circuitry 1446 may provide pre-boot code. The I/F 1442 may also be coupled to a network interface circuit (NIC) 1480 for connections off-chip.

Furthermore, chipset 1432 includes the I/F 1438 to couple chipset 1432 with a high-performance graphics engine, such as, graphics processing circuitry or a graphics processing unit (GPU) 1448. In other embodiments, the computing architecture 1400 includes a flexible display interface (FDI) (not shown) between the processor 1404 and/or the processor 1406 and the chipset 1432. The FDI interconnects a graphics processor core in one or more of processor 1404 and/or processor 1406 with the chipset 1432.

The computing architecture 1400 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1454 and/or vision processing unit 1456 are coupled to chipset 1432 via I/F 1438. The accelerator 1454 is representative of any type of accelerator device (e.g., a data streaming accelerator, cryptographic accelerator, cryptographic co-processor, an offload engine, etc.). One example of an accelerator 1454 is the Intel® Data Streaming Accelerator (DSA). The accelerator 1454 is a device including circuitry to accelerate copy operations, data encryption, hash value computation, data comparison operations (including comparison of data in memory 1416 and/or memory 1418), and/or data compression. Examples for the accelerator 1454 include a USB device, PCI device, PCIe device, CXL device, UCIe device, and/or an SPI device. The accelerator 1454 also includes circuitry arranged to execute machine learning (ML) related operations (e.g., training, inference, etc.) for ML models. Generally, the accelerator 1454 is specially designed to perform computationally intensive operations, such as hash value computations, comparison operations, cryptographic operations, and/or compression operations, in a manner that is more efficient than when performed by the processor 1404 or processor 1406. Because the load of the computing architecture 1400 includes hash value computations, comparison operations, cryptographic operations, and/or compression operations, the accelerator 1454 greatly increases performance of the computing architecture 1400 for these operations.

The accelerator 1454 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1454. For example, the accelerator 1454 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1454 via a non-posted write (e.g., a deferred memory write (DMWr)). One example of an instruction that atomically submits a work descriptor to the shared work queue of the accelerator 1454 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1454. The dedicated work queue may accept job submissions via commands such as the movdir64b instruction.

Various I/O devices 1460 and display 1452 couple to the bus 1472, along with a bus bridge 1458 which couples the bus 1472 to a second bus 1474 and an I/F 1440 that connects the bus 1472 with the chipset 1432. In one embodiment, the second bus 1474 is a low pin count (LPC) bus. Various input/output (I/O) devices couple to the second bus 1474 including, for example, a keyboard 1462, a mouse 1464 and communication devices 1466.

Furthermore, an audio I/O 1468 couples to second bus 1474. Many of the I/O devices 1460 and communication devices 1466 reside on the system-on-chip (SoC) 1402 while the keyboard 1462 and the mouse 1464 are add-on peripherals. In other embodiments, some or all the I/O devices 1460 and communication devices 1466 are add-on peripherals and do not reside on the system-on-chip (SoC) 1402.

FIG. 15 illustrates a block diagram of an exemplary communications architecture 1500 suitable for implementing various embodiments as previously described. The communications architecture 1500 includes various common communications elements, such as a transmitter, receiver, transceiver, radio, network interface, baseband processor, antenna, amplifiers, filters, power supplies, and so forth. The embodiments, however, are not limited to implementation by the communications architecture 1500.

As shown in FIG. 15, the communications architecture 1500 includes one or more clients 1502 and servers 1504. The clients 1502 and the servers 1504 are operatively connected to one or more respective client data stores 1508 and server data stores 1510 that can be employed to store information local to the respective clients 1502 and servers 1504, such as cookies and/or associated contextual information.

The clients 1502 and the servers 1504 communicate information between each other using a communication framework 1506. The communication framework 1506 implements any well-known communications techniques and protocols. The communication framework 1506 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1506 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/900/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1502 and the servers 1504. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

What is claimed is:

1. The computer-implemented, method comprising:
sending a query to a prior art system to identify related prior art for the newly identified idea;
determining a patentability score, a business value score, a detectability score, or a combination thereof for the newly identified idea;
determining whether additional information for the newly identified idea is required based on the patentability score, the business value score, the detectability score, or the combination thereof;
repeatedly requesting the additional information on one or more communication mediums of a business system in response to continuing determining the additional information is required or a timeout event occur; and
performing one or more actions in response to determining the additional information is not required, wherein the one or more actions includes presenting data based on the patentability score, the business value score, the detectability score, or the combination thereof, generating a disclosure form for the newly identified idea, notifying a system associated with a portfolio manager, or a combination thereof.

2. The method of claim 1, wherein the query comprises text identified in one or more communication mediums.

3. The method of claim 1, wherein the patentability score is based on a count of a number of documents identified in a similarity analysis within a defined distance text of the newly identified idea.

4. The method of claim 1, wherein the business value score is based on a total of numerical values assigned to one or more considerations comprising market demand, potential revenue generation, competitive advantage, and alignment with company goals or objectives.

5. The method of claim 1, wherein the detectability score is based on one or more factors comprising a nature of the newly identified idea and industry and market factors.

6. The method of claim 1, comprising:
determining additional information is required based on the patentability score not meeting a threshold requirement; and
determining additional information is not required based on the patentability score meeting a threshold requirement.

7. A computing apparatus comprising:
a processor; and
a memory storing instructions that, when executed by the processor, configure the apparatus to:
send a query to a prior art system to identify related prior art for a newly identified idea;
determine a patentability score, a business value score, a detectability score, or a combination thereof;
determine whether additional information for the newly identified idea is required based on the patentability score, the business value score, the detectability score, or the combination thereof;
repeatedly request the additional information on one or more communication mediums of a business system in response to continuing determining the additional information is required or a timeout event occur; and
perform one or more actions in response to determining the additional information is not required, wherein the one or more actions includes presenting data based on the patentability score, the business value score, the detectability score, or the combination thereof, generating a disclosure form for the newly identified idea, notifying a system associated with a portfolio manager, or a combination thereof.

8. The computing apparatus of claim 7, wherein the query comprises text identified in one or more communication mediums.

9. The computing apparatus of claim 7, wherein the patentability score is based on a count of a number of documents identified in a similarity analysis within a defined distance text of the newly identified idea.

10. The computing apparatus of claim 7, wherein the business value score is based on a total of numerical values assigned to one or more considerations comprising market demand, potential revenue generation, competitive advantage, and alignment with company goals or objectives.

11. The computing apparatus of claim 7, wherein the detectability score is based on one or more factors comprising a nature of the newly identified idea and industry and market factors.

12. The computing apparatus of claim 7, comprising:
determine additional information is required based on the patentability score not meeting a threshold requirement; and
determine additional information is not required based on the patentability score meeting a threshold requirement.

13. A non-transitory computer-readable storage medium, the computer-readable storage medium including instructions that when executed by a computer, cause the computer to:
send a query to a prior art system to identify related prior art for a newly identified idea;
determine a patentability score, a business value score, a detectability score, or a combination thereof;
determine whether additional information for the newly identified idea is required based on the patentability score, the business value score, the detectability score, or the combination thereof;
repeatedly request the additional information on one or more communication mediums of a business system in response to continuing determining the additional information is required or a timeout event occur; and
perform one or more actions in response to determining the additional information is not required, wherein the one or more actions includes presenting data based on the patentability score, the business value score, the detectability score, or the combination thereof, generating a disclosure form for the newly identified idea, notifying a system associated with a portfolio manager, or a combination thereof.

14. The computer-readable storage medium of claim 13, wherein the query comprises text identified in one or more communication mediums.

15. The computer-readable storage medium of claim 13, wherein the patentability score is based on a count of a number of documents identified in a similarity analysis within a defined distance text of the newly identified idea.

16. The computer-readable storage medium of claim 13, wherein the business value score is based on a total of numerical values assigned to one or more considerations comprising market demand, potential revenue generation, competitive advantage, and alignment with company goals or objectives.

17. The computer-readable storage medium of claim 13, wherein the detectability score is based on one or more factors comprising a nature of the newly identified idea and industry and market factors.

18. The computer-readable storage medium of claim 13, comprising:
determine additional information is required based on the patentability score not meeting a threshold requirement; and
determine additional information is not required based on the patentability score meeting a threshold requirement.

19. A computer-implemented method, comprising:
providing, by a system, a form in a user interface comprising one or more fields for text entry, each of the one or more fields corresponding to information about an invention idea;
processing, by the system, text entered in a field of the one or more fields through a machine learning model;
generating, by the system, a score for the text based on the processing the text through the ML model;
providing, by the system, feedback as a prompt in the user interface based on the score; and
receiving, by the system, at least one update to in the one or more fields.

20. The computer-implemented method, comprising:
tracking a communication of an idea on one or more communication mediums;
logging the communication with the idea and sending the communication to a machine learning (ML) model for analysis to determine a categorization;
identifying a beginning of a discussion of the idea in the communication;
continuing tracking the communication until an end of the discussion;
organizing the idea into a new format to perform a prior art analysis;
sending the reformatted idea to the prior art system;
determining a result of a prior art search of the prior art system;
generating a patentability score for the idea;
if the patentability score fails to meet a first threshold requirement, the system performs no further action unless the idea gains new context;
if the patentability score is between the first threshold requirement and a second threshold requirement, prompting, by the system, for additional information for the idea;
if the patentability score is above the second threshold requirement, performing an action for the idea, the action comprising one of sending the idea to one or more devices associated with a business manager, a patent manager, a patent attorney, a law firm, initiating a patent drafting process for the idea, generating an invention disclosure form for the idea, or combination thereof.
